(19) United States
(12) Patent Application Publication
(10) Pub. No.: US 2002/0032692 A1
(43) Pub. Date: Mar. 14, 2002

(54) Workflow management method and workflow management system of controlling workflow process

(76) Inventors: Atsuhito Suzuki, Yokohama (JP); Nobuo Beniyama, Kawasaki (JP); Yoshiki Matsuda, Tokyo (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/924,505

(22) Filed: Aug. 9, 2001

(30) Foreign Application Priority Data
Sep. 8, 2000 (JP) 2000-278673

(51) Int. Cl. G06F 12/00

(52) U.S. Cl. 707/200; 717/100

(57) ABSTRACT

A workflow management system has synchronousness information, which can be set by a process definition tool in a process definition, for specifying a processing mode for calling a state transition request application programming interface (API). The synchronousness is controlled using a state transition request synchronous process program and a state transition request asynchronous process program. The synchronous process program processes a state transition in a synchronous processing mode in which the state transition is processed from receipt of an inputted state transition request to return of a response. The asynchronous process program processes a state transition in an asynchronous processing mode in which a state transition for a process instance is processed after an inputted state transition request is received and a response is returned. The synchronousness information is referenced to determine whether a state transition is processed in the synchronous or asynchronous processing mode.

### BACKGROUND OF THE INVENTION

The present invention relates to a technology for controlling a workflow management system.

A workflow management system refers to a software program for managing states of works and allocation of works to participants based on a previously defined workflow. In the following, information represented by contents of a defined workflow is referred to as the “process definition.”

A workflow management system is described, for example, in WfMC: The Workflow Reference Model (TC00-1003, Jan-1995 1.1), and WfMC: Workflow Management Application Programming Interface (Interface 2 & 3) Specification (WFMC-TC-1009, July-1998 2.0).

According to these documents, a workflow management system provides a programming interface for use by a client application. In the following, the client application is referred to as the “workflow application.” Also, a programming interface is hereinafter abbreviated as API (Application Programming Interface).

The API provided by a workflow management system to a workflow application is an interface for requesting for operations associated with process instances such as introduction of a process instance, search, state transitions such as start and end, and deletion. As the workflow application operates using these APIs, the workflow management system manages the states of process instances, and allocates the process instances to users in accordance with a process definition. In the following, a request to the workflow management system for a process instance state transition operation is referred to as the “state transition request.” Also, an interface for requesting for a process instance state transition operation is referred to as the “state transition requesting API.”

Processing modes possibly taken by the workflow management system for responding to a state transition request from a workflow application may be classified into an asynchronous processing mode and a synchronous processing mode.

The asynchronous processing mode performs only processing involved in storing information related to a state transition request in a persistent storage means, and returns a response to a calling workflow application. Actual state transition processing is executed at a later timing by fetching the information on the state transition request from the persistent storage means.

The synchronous processing mode executes actual state transition processing from a state transition request to return of a response to a workflow application.

In view of the performance of the state transition, the asynchronous processing mode presents a less turn around time (API response time), which is a time taken from a state transition request to a response returned to a workflow application, because fewer processing is performed at the time a state transition request is made. On the other hand, the asynchronous processing mode presents a more state transition time, which is a time required from a state transition request to completion of actual state transition processing, because immediate execution is not ensured and information on the state transition request is once stored in a persistent storage means and fetched therefrom.

In contrast, the synchronous processing mode presents a more turn around time because much processing is performed at the time a state transition request is made. On the other hand, the synchronous processing mode presents a less state transition time because the state transition request is not stored in a persistent storage means or fetched therefrom, and immediate execution is ensured.

Generally, a less turn around time leads to a higher operability of a workflow application. Also, a less state transition time permits the next participant to start a work at earlier timing.

Conventionally, the workflow management systems have been applied only to auxiliary works such as purchase activities and travel expense adjustment in enterprises, so that the state transition time has not been a critical issue. Rather, a reduction in API response time has been given preference for improving the operability of the workflow application. For this reason, the asynchronous processing mode has been a dominant processing mode for an API call in the conventional workflow management systems.

In recent years, as an applicable range of the workflow management systems has been increasingly extended to the basic business activities, the workflow management systems have been applied to business activities which are processed while customers are kept waiting, such as window services. In this event, a workflow management system based on the synchronous processing mode is more effective since a reduction in state transition time is more important.

A major advantage provided by introducing a workflow management system lies in that the workflow management system is relied on to control a sequence of flowing works in a business such that developers of workflow applications for executing respective works can concentrate only on implementation of business logics for the respective works in the business, and that program source codes need not be changed even if the flow of works in the business is modified. In the following, a program for implementing the business logic for each work is referred to as the “workflow business process program.” Also, a source code developed by a programmer of a workflow application is referred to as the “user developed code.”

### SUMMARY OF THE INVENTION

The conventional workflow management systems are problematic in view of flexibility because a processing mode for a state transition request API call is fixed for each workflow management system.

It is an object of the present invention to provide a more flexible workflow management system.

To solve the problem mentioned above and achieve the object of the present invention, the present invention provides three solutions.

A workflow management system of the present invention in a first solution, includes synchronousness information in a process definition for specifying a processing mode for calling a state transition request API, and has a process definition tool which can set the synchronousness information in the process definition. The workflow management system has a state transition request synchronous process program for processing a state transition in a synchronous processing mode; a state transition request asynchronous process program for processing a state transition in an asynchronous processing mode; and a process method determination program for referencing the synchronousness information in the process definition to determine whether a state transition is processed in the synchronous processing mode or the asynchronous processing mode.

A workflow management system of the present invention in a second solution provides a synchronous state transition request API for specifying a state transition process in a synchronous processing mode, and an asynchronous state transition request API for specifying a state transition process in an asynchronous processing mode, and has a state transition request synchronous process program for processing a state transition in the synchronous processing mode, and a state transition request asynchronous process program for processing a state transition in the asynchronous processing mode. The workflow management system also has a workflow application generating tool linked to a workflow application for generating a source code of a state transition request issue program for calling a state transition request API of the workflow management system. The tool inputs synchronousness information for specifying a processing mode for a state transition request to selectively generate a source code of a state transition request issue program for calling the synchronous state transition request API or the asynchronous state transition request API depending on the synchronousness information.

A workflow management system of the present invention in a third solution provides a synchronous state transition request API for specifying a state transition process in a synchronous processing mode, and an asynchronous state transition request API for specifying a state transition process in an asynchronous processing mode, and has a state transition request synchronous process program for processing a state transition in the synchronous processing mode, and a state transition request asynchronous process program for processing a state transition in the asynchronous processing mode. Workflow application run time execution environment information, accessible from a workflow application includes synchronousness information for specifying a processing mode for a state transition request. The workflow management system has a process definition tool which can set the synchronous information in the workflow application run time execution environment information, and a state transition request issue program linked to the workflow application for calling a state transition request API of the workflow management system. The state transition request issue program references the synchronousness information in the workflow application run time execution environment information to selectively call the synchronous state transition request API or the asynchronous state transition request API.

### BRIEF DESCRIPTION OF THE DRAWINGS

FIG. 1 is a block diagram illustrating a workflow management system according to a first embodiment of the present invention;

FIG. 2 is a block diagram illustrating the configuration of the workflow management system according to the first embodiment of the present invention;

FIG. 3 is a flow diagram generally illustrating an operational flow of the workflow management system according to the first embodiment of the present invention;

FIG. 4 shows the structure of a state definition table according to the first embodiment of the present invention;

FIG. 5 shows the structure of a transition definition table according to the first embodiment of the present invention;

FIG. 6 shows the structure of a participant determining rule definition table according to the first embodiment of the present invention;

FIG. 7 shows the structure of a participant definition table according to the first embodiment of the present invention;

FIG. 8 shows the structure of a process instance state table according to the first embodiment of the present invention;

FIG. 9 shows the structure of a state transition request table according to the first embodiment of the present invention;

FIG. 10 shows the structure of a window service table according to the first embodiment of the present invention;

FIG. 11 shows an application programming interface (API) of a workflow management program according to the first embodiment of the present invention;

FIG. 12 is a flow chart illustrating a routine of a process method determination procedure according to the first embodiment of the present invention;

FIG. 13 is a flow chart illustrating a routine of a state transition process procedure according to the first embodiment of the present invention;

FIG. 14 illustrates a process definition screen according to the first embodiment of the present invention;

FIG. 15 shows the structure of a process definition according to the first embodiment of the present invention;

FIG. 16 is a block diagram illustrating the configuration of a workflow management system according to a second embodiment of the present invention;

FIG. 17 shows the structure of a transition definition table according to the second embodiment of the present invention;

FIG. 18 shows the structure of a state transition request table according to the second embodiment of the present invention;

FIG. 19 is an application programming interface (API) of a workflow management program according to the second embodiment of the present invention;

FIG. 20 is a flow chart illustrating a routine of a synchronous state transition request procedure according to the second embodiment of the present invention;

FIG. 21 is a flow chart illustrating a routine of an asynchronous state transition request procedure according to the second embodiment of the present invention;

FIG. 22 is a flow chart illustrating a routine of a state transition process procedure according to the second embodiment of the present invention;

FIG. 23 illustrates a transition method selection screen according to the second embodiment of the present invention;

FIG. 24 is a block diagram illustrating the configuration of a workflow management system according to a third embodiment of the present invention;

FIG. 25 shows the structure of workflow application run time execution environment information according to the third embodiment of the present invention;

FIG. 26 illustrates a transition method selection screen according to the third embodiment of the present invention;

FIG. 27 is a block diagram illustrating the configuration of a workflow management system according to a fourth embodiment of the present invention;

FIG. 28 shows the structure of a process definition table according to the fourth embodiment of the present invention;

FIG. 29 illustrates a process definition screen according to the fourth embodiment of the present invention;

FIG. 30 shows the structure of a process definition according to the fourth embodiment of the present invention;

FIG. 31 is a block diagram illustrating the configuration of a workflow management system according to a fifth embodiment of the present invention;

FIG. 32 shows the structure of a process definition table according to the fifth embodiment of the present invention;

FIG. 33 is a flow chart illustrating a routine of a state transition request fetch procedure according to the fifth embodiment of the present invention;

FIG. 34 illustrates a process definition screen according to the fifth embodiment of the present invention; and

FIG. 35 shows the structure of a process definition according to the fifth embodiment of the present invention.

### DETAILED DESCRIPTION OF THE EMBODIMENTS

In the following, embodiments of the present invention will be described with reference to the accompanying drawings.

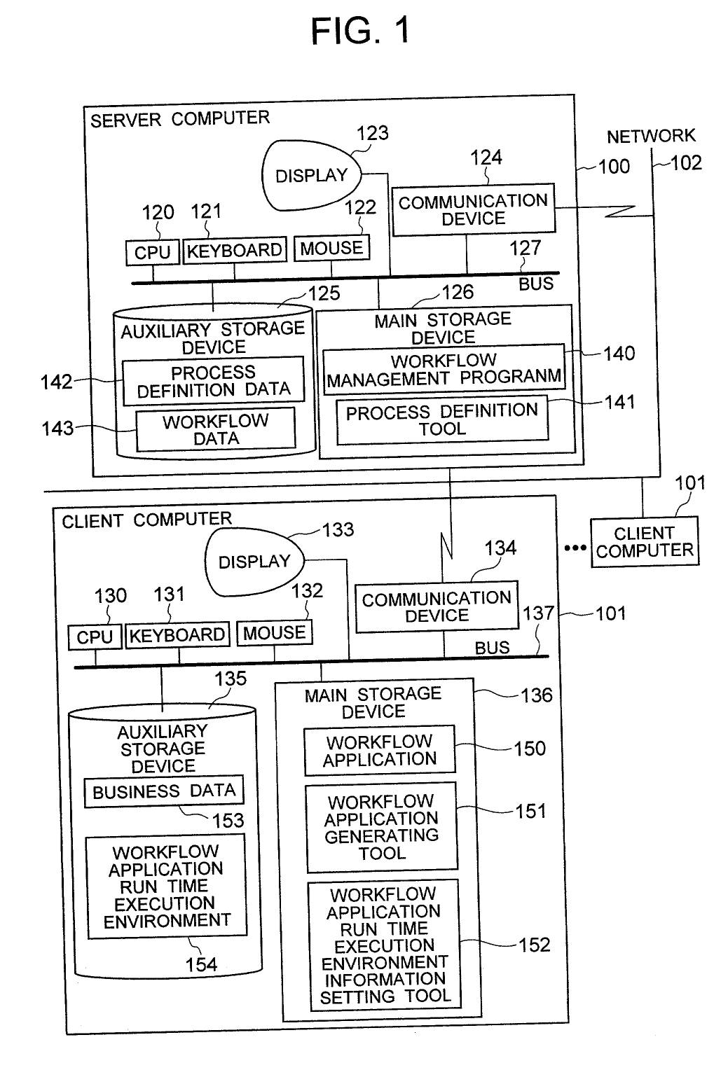

A first embodiment shows a specific example of an aspect of Solution 1 which will be described with reference to FIGS. 1 through 15.

A workflow management system according to the first embodiment is characterized in that the state transition request API provided by a workflow management program is limited to one type, wherein synchronous information previously defined for process definition data is referenced to determine whether processing for a state transition request is performed in a synchronous mode or an asynchronous mode within the workflow management program, thereby eliminating information related to methods of processing state transition requests from source codes of workflow business process programs.

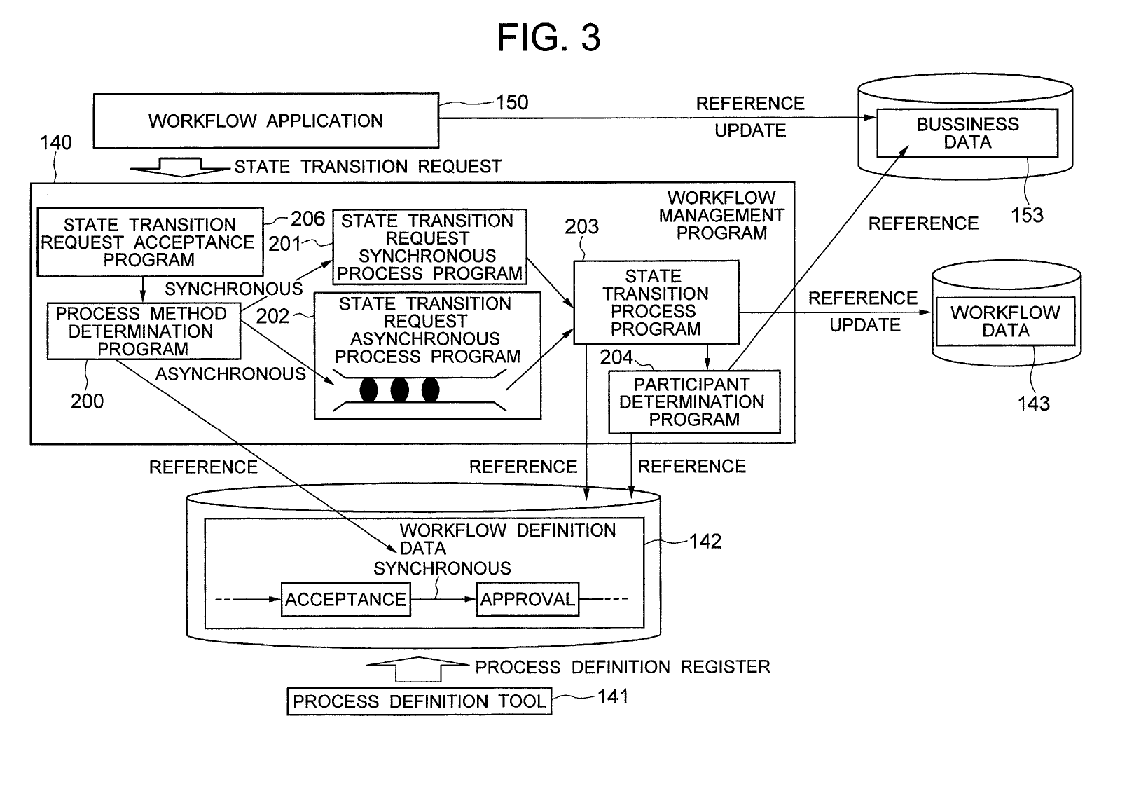

Now, the basic operational principle of the first embodiment will be outlined with reference to FIG. 3.

The user of the workflow management system uses a process definition tool 141 to define possible states taken by process instances and transitions between the respective states as a process definition, and stores the process definition in the process definition data 142. In this event, the user can set for each of transitions in the process definition whether a transition process associated therewith is performed in a synchronous mode or an asynchronous mode.

A workflow application 150 has a workflow business process program 3207 which references and updates business data 153, and issues state transition request API for a workflow management program 140 to implement business logic.

A state transition request accept program 206 receives a state transition request API of the workflow application 150 to call a process method determination program 200. The process method determination program 200 references the process definition data 142 to determine whether a requested transition is processed in the synchronous mode or the asynchronous mode, and calls a state transition request synchronous process program 201 when it determines the request transition is processed in the synchronous mode, and otherwise calls a state transition request asynchronous process program 202. The state transition request synchronous process program 201 directly calls a state transition process program 203, and does not returns a response to a caller until the state transition of a process instance is completed. The state transition request asynchronous process program 202 only executes a process for once holding the state transition process request in a persistent storage, and returns a response to a caller. The actual state transition process is performed at a later time by fetching the state transition request from the persistent storage and calling the state transition process program 203. The state transition process program 203 references the process definition data 142, calls a participant determination program 204 to determine a participant for a process instance, and executes the state transition process while updating workflow data 143. The participant determination program 204 references the process definition data 142, and also references business data 153 as required to determine a participant.

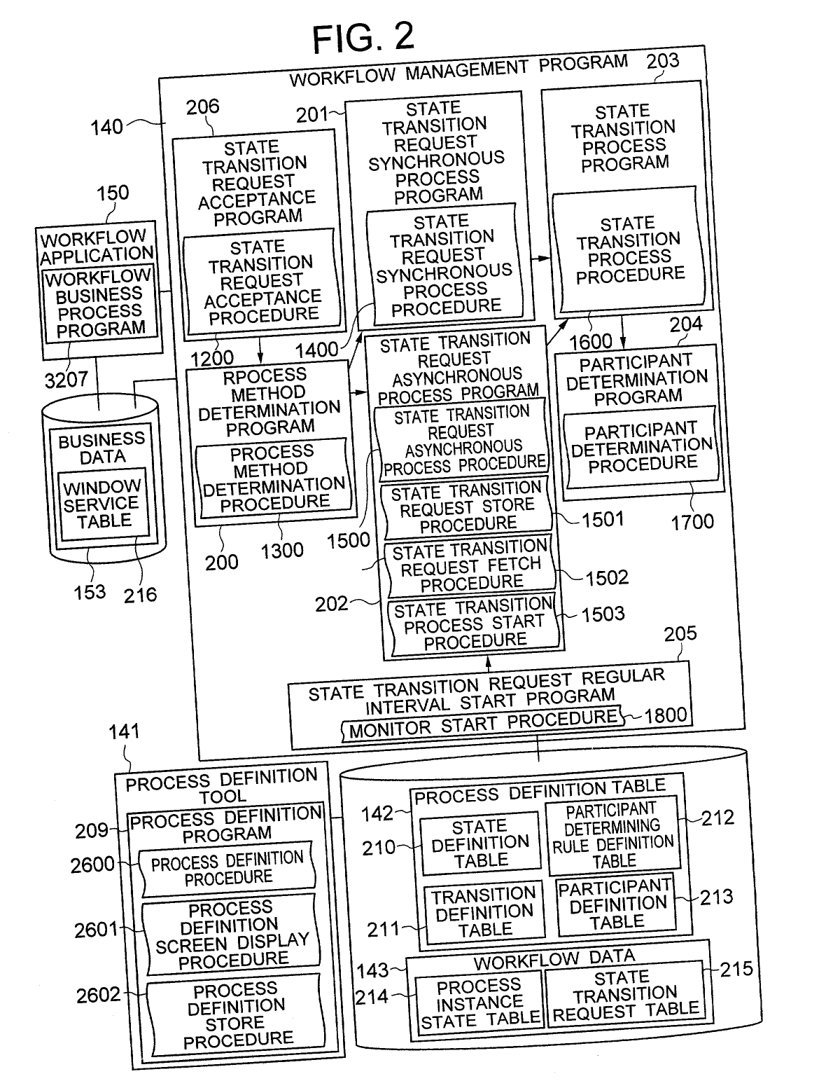

Next, the configuration of the workflow management system according to the first embodiment will be described with reference to FIG. 2.

The workflow management system of the first embodiment comprises a workflow management program 140 which provides the workflow application 150 with APIs for manipulating the states of process instances, as represented by the state transition request API, and manages the states of process instances and allocation of the process instances to participants while accessing to the process definition data 142, workflow data 143 and business data 153; a process definition tool 141 which defines a workflow and stores the workflow in the process definition data 142; the process definition data 142 which stores process definitions such as possible states and transitions taken by process instances, participant determining rules, and so on; the workflow data 143 which stores the states of works; and a workflow application 150 which accesses the business data 153 for a business which is applied with the workflow management system to call and execute APIs provided by the workflow management program 140; and the business data 153 which stores business dependent data.

The process definition data 142 comprises a state definition table 210 for storing definitions of possible states taken by process instances that depend on each process definition; a transition definition table 211 for storing definitions of possible transitions between states taken by process instances that belong to each process definition; a participant determining rule definition table 212 for storing definitions of participant determining rules for use in determining a participant in each state; and a participant definition table 213 for storing definitions of participants. In the first embodiment, participant definition information is included in the workflow management system. Alternatively, the participant definition information may be stored in any external database. In either of cases, it is assumed that the participant definition information is managed by a business dependent participant management mechanism.

The workflow data 143 comprises a process instance state table 214 for storing the states of process instances, and state transition request table 215 for storing state transition requests.

The process instance data 153 in the first embodiment comprises a window service table 216 for storing data depending on window services used in the first embodiment.

The workflow management program 140 comprises a process method determination program 200 which assigns a process to the state transition request synchronous process program 201 or the state transition request asynchronous process program 202 in accordance with the contents of the transition definition table 211; the state transition request synchronous process program 201 which calls the state transition process program 203 to implement the synchronous processing of a state transition request; the state transition request asynchronous process program 202 which stores a state transition request in the state transition request table 215, fetches the state transition request from the state transition request table 215 at a timing at which it is called by a state transition request regular interval start program 205, and calls the state transition process program 203 to implement the asynchronous processing of the state transition request; the state transition process program 203 which references the process definition data 142, calls a participant determination program 204, and updates the process instance state table 214 to implement a state transition of a process instance; a participant determination program 204 which references the participant determining rule definition table 212 to evaluate the participant determining rules, and accesses the participant definition table 213 and the window service table 216 as required to determine an appropriate participant for each service; the state transition request regular interval start program 205 which periodically calls the state transition request asynchronous process program 202 to give an asynchronous execution trigger for a state transition; and the state transition request acceptance program 206 which accepts a call for a state transition request API to call the process method determination program 200.

The process definition tool 141 comprises a process definition program 209 which provides a workflow defining person with GUI for creating a process definition, and stores the created process definition in the process definition data 142.

In the following the first embodiment will be described in detail.

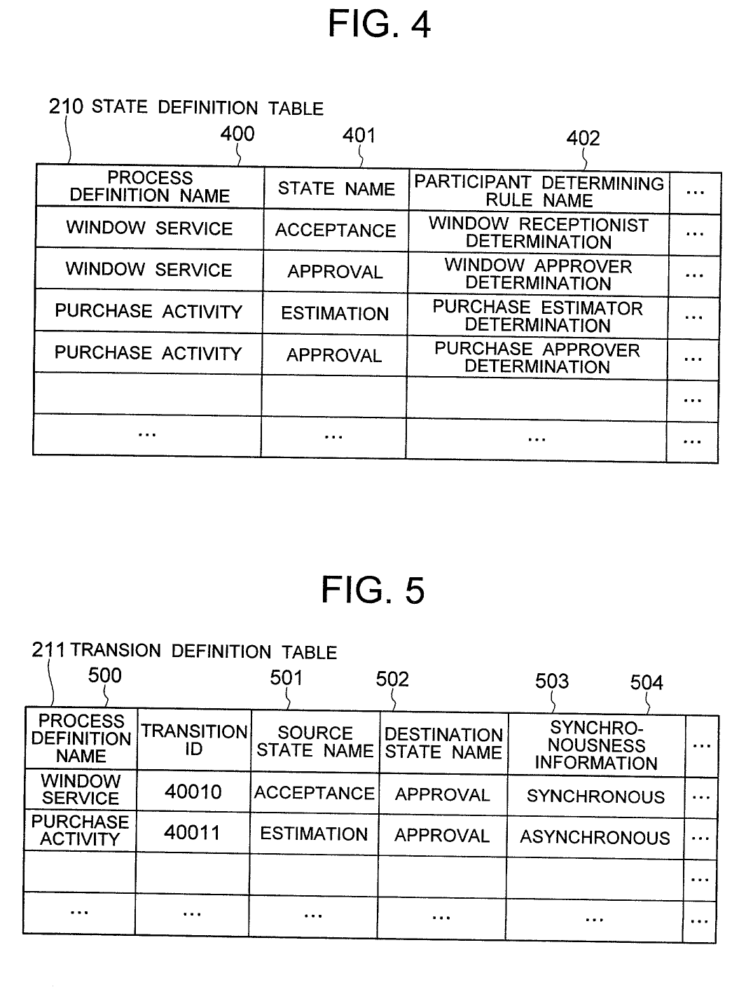

To begin with, tables which constitute the process definition data 142 will be described with reference to FIGS. 4 through 7. FIG. 4 shows the structure of the state definition table 210. The state definition table 210 is tabular data comprised of a process definition name 400, a state name 401, and a participant determining rule name 402. The process definition name 400 indicates a process definition to which a state belongs. The state name 401 is data for uniquely identifying a state within the same process definition. The participant determining rule name 402 references a participant determining rule name 600 in the participant determining rule definition table 212.

A record in the state definition table 210 is stored by a process definition store procedure 2602 of the process definition program 209, and referenced by a state transition process procedure 1600 of the state transition process program 203.

FIG. 5 shows the structure of the transition definition table 211. The transition definition table 211 is tabular data comprised of a process definition name 500, a transition ID 501, a source state name 502, a destination state name 503, and synchronousness information 504. The process definition name 500 indicates a process definition to which a transition belongs. The transition ID 501 is data for uniquely identifying the transition in the same process definition. The source state name 502 indicates the name of a state which is the source of the transition. The destination state name 503 indicates the name of a state which is the destination of the transition. The synchronousness information 504 specifies whether a state transition request is processed in the synchronous mode or the asynchronous mode, and takes a value “synchronous” or “asynchronous.”

A record in the transition definition table 211 is stored by the process definition store procedure 2602 of the process definition program 209, and referenced by the process method determination procedure 1300 of the process method determination program 200 and by the state transition process procedure 1600 of the state transition process program 203.

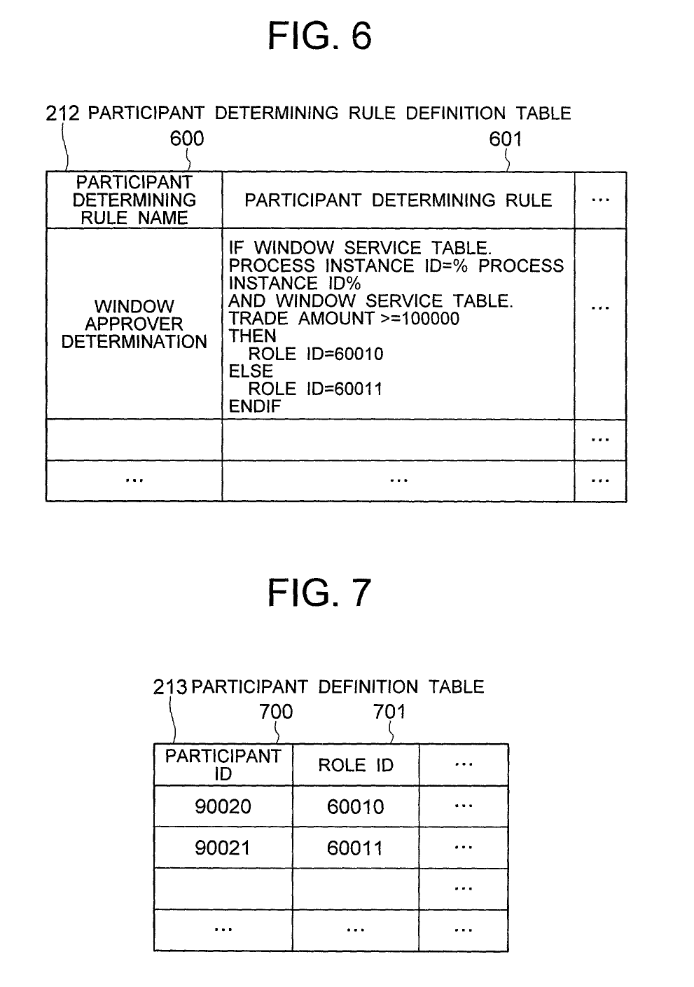

FIG. 6 shows the structure of the participant determining rule definition table 212. The participant determining rule definition table 212 is tabular data comprised of a participant determining rule name 600, and a participant determining rule 601. The participant determining rule name 600 is data for uniquely identifying the participant determining rule 601. The participant determining rule 601 is character string data which is interpreted by the participant determination program 204.

A record in the participant determining rule definition table 212 is stored by some method before storing a record in the state definition table 210 which references the participant determining rule name 600 of the record, and referenced by a participant determination procedure 1700 of the participant determination program 204.

FIG. 7 shows the structure of the participant definition table 213. The participant definition table 213 is tabular data comprised of a participant ID 700 and a role ID 701. The participant ID 700 is data for uniquely identifying a participant. The role ID 701 is an example of attributes to a participant which is referenced for evaluating a participant determining rule in the first embodiment.

A record in the participant definition table 213 is managed in association with a business dependent participant management mechanism, and stored, modified and deleted by some method. In the workflow management system, records in the participant definition table 213 are referenced as required by the participant determination procedure 1700 of the participant determination program 204.

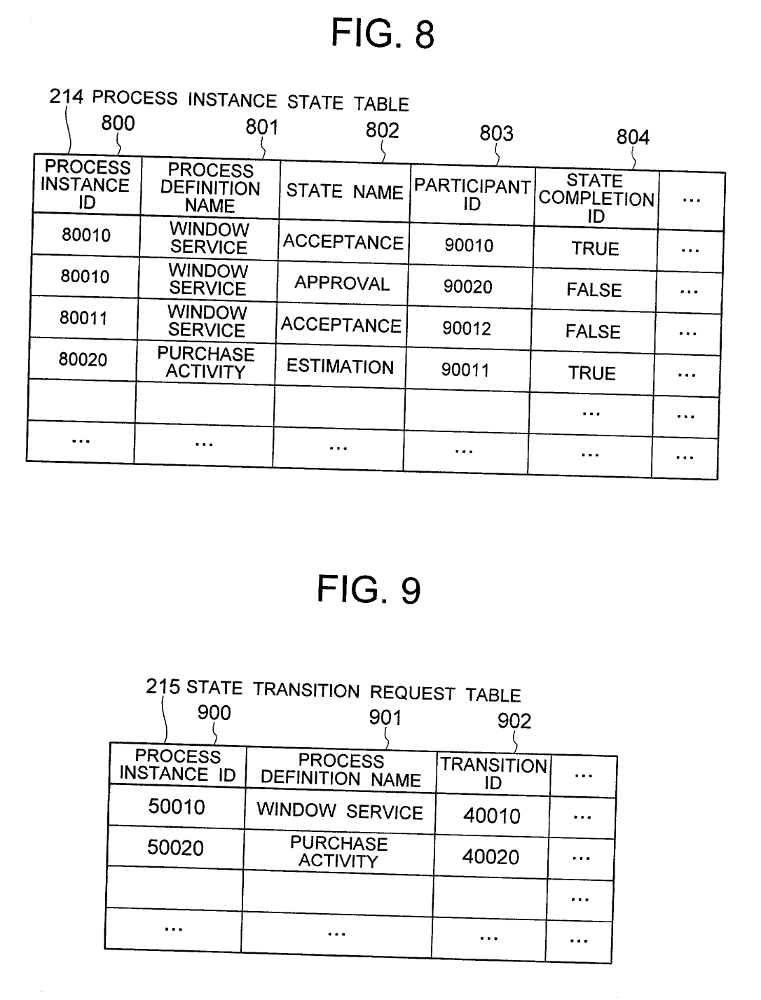

Next, tables which constitute the workflow data 143 will be described with reference to FIGS. 8 and 9.

FIG. 8 shows the structure of the process instance state table 214. The process instance state table 214 is tabular data comprised of a process instance ID 800, a process definition name 801, a state name 802, a participant ID 803, and a state completion flag 804. The process instance ID 800 is data for uniquely identifying a process instance. The process definition name 801 is the name of a process definition to which a process instance belongs. The state name 802 is data indicative of the state of the process instance. The participant ID 803 is information for identifying a participant who has been determined as a participant for the state as indicated by the state name 802 of the process instance. The state completion flag 804 is a flag indicating whether or not the process instance is completed.

In the workflow management system of the first embodiment, the processing for the state transition is implemented by inserting into the process instance state table 214 a record which has the state completion flag 804 of a source state set to TRUE, the state name 802 set to the state name of a destination state, and the state completion flag 804 to FALSE.

A record in the process instance state table 214 is stored and updated by the state transition process procedure 1600 of the state transition process program 203, and referenced by the process method determination procedure 1300.

FIG. 9 shows the structure of the state transition request table 215. The state transition request table 215 is tabular data comprised of a process instance ID 900, a process definition name 901, and a transition ID 902. The process instance ID 900 is an identifier of a process instance which is associated with a state transition request. The process definition name 901 is the name of a process definition on which a process instance, associated with a state transition request, is dependent. The transition ID 902 is an identifier of a transition which has the source state as specified by the state transition request API.

A record in the state transition request table 215 is stored by a state transition request store procedure 1501 of the state transition request asynchronous process program 202, and referenced and deleted by a state transition request fetch procedure 1502 of the state transition request asynchronous process program 202.

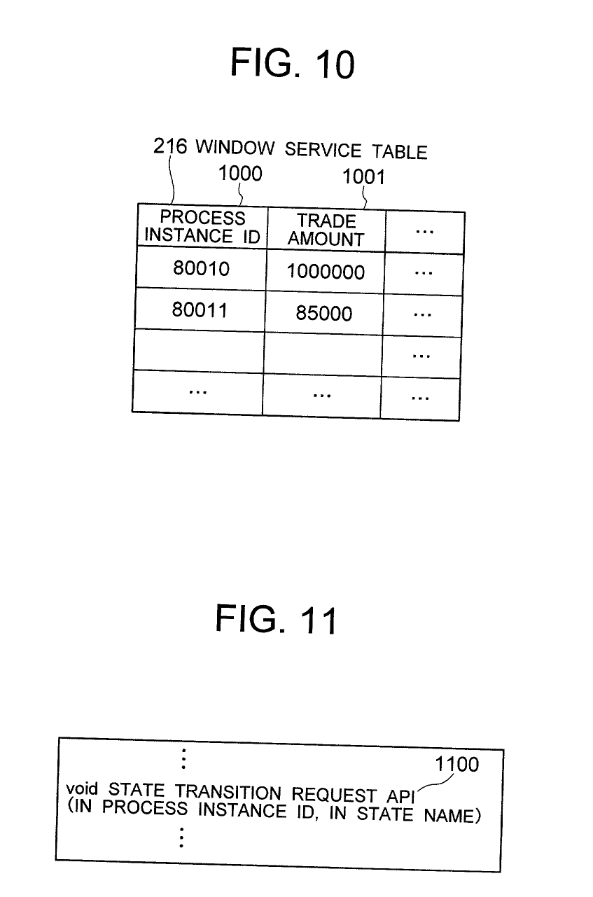

Next, a table constituting the business data 153 will be described with reference to FIG. 10.

A window service table 216 is tabular data comprised of a process instance ID 1000 and a trade amount 1001 for storing business dependent data of a window service referenced in the first embodiment.

A record in the window service table 216 is stored, referenced and updated by a workflow business process program 3207, and referenced as required by the participant determination procedure 1700 of the participant determination program 204.

In the following, the operation of the workflow management program 140 will be described in detail with reference to FIGS. 11 through 13. FIG. 11 shows API provided by the workflow management program 140 which includes state transition request API 1100. The state transition request API 1100 takes a process instance ID and a state name as input arguments.

The configuration of each program will be described below.

The state transition request acceptance program 206 comprises a state transition request procedure 1200 which implements the processing of the state transition request API 1100.

The process method determination program 200 comprises a process method determination procedure 1300 which references the workflow data 143 and the process definition data 142 to determine a processing mode for a state transition request. The state transition request synchronous process program 201 comprises a state transition request synchronous process procedure 1400.

The state transition request asynchronous process program 202 comprises a state transition request asynchronous process procedure 1500; a state transition request store procedure 1501 for storing a state transition request in a persistent storage; a state transition request fetch procedure 1502 for fetching a state transition request from the persistent storage; and a state transition process start procedure 1503 which is called at regular intervals to fetch a state transition request stored in the persistent storage and start the state transition process program 203.

The state transition process program 203 comprises a state transition process procedure 1600 for executing the actual state transition process.

The participant determination program 204 comprises a participant determination procedure 1700 which references the process definition data 142 and also references the business data 153 as required to determine a participant.

The state transition request regular interval start program 205 comprises a monitor start procedure 1800 which is called when the workflow management program 1400 is started to call the state transition process start procedure 1503 at regular intervals.

In continuation, the operation of each procedure will be described.

First, the state transition request procedure 1200, which is a procedure for implementing the state transition request API 1100, passes arguments as they are, and calls the process method determination procedure 1300.

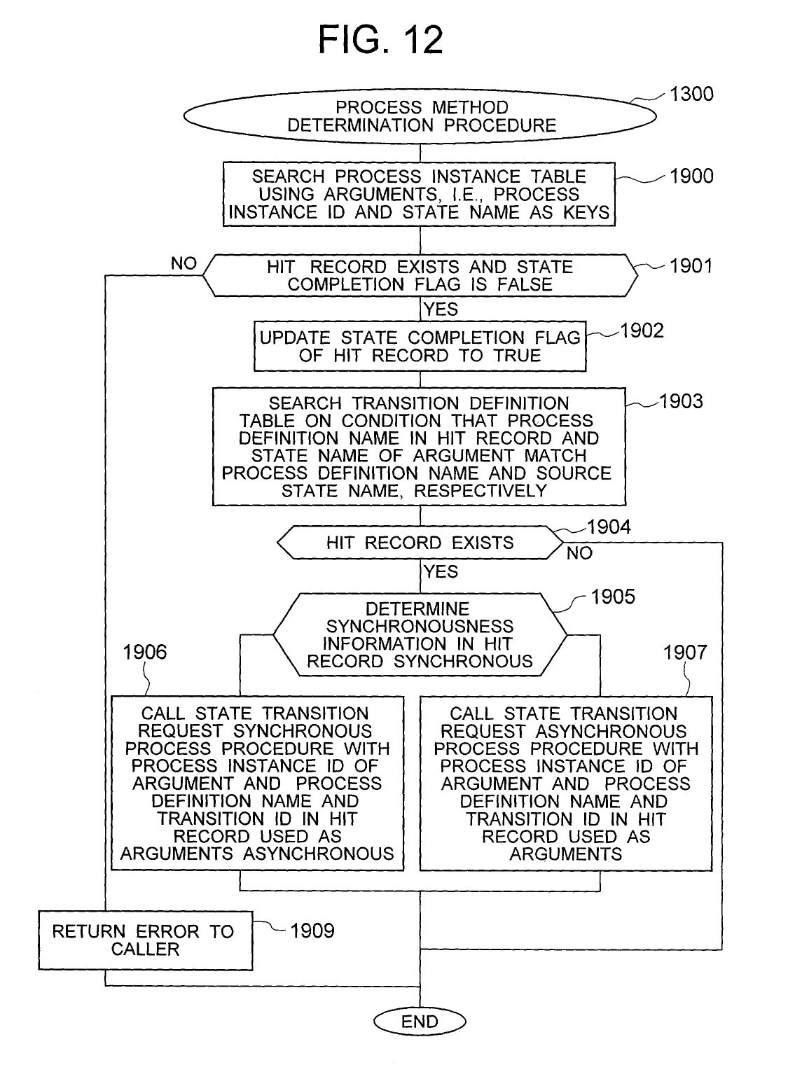

Next, the operation of the process method determination procedure 1300 will be described with reference to FIG. 12.

The process method determination procedure 1300 takes a process instance ID and a state name as arguments. First, the procedure 1300 searches the process instance state table 214 using the values of the process instance ID and state name, which are arguments, as keys (1900). In this event, if no hit record is found in the process instance state table 214, or if the state completion flag 804 in a hit record has a field value equal to TRUE (1901), the procedure 1300 returns an error to a caller (1909), followed by termination of the flow. Otherwise, the procedure 1300 updates the field value of the state completion flag 804 in the record hit in the search at step 1900 to TRUE (1902). Next, on condition that the field value of the process definition name 801 of the record hit in the search at step 1900 and the value of the state name, one of the argument, match the process definition name 500 and the source state name 502 in the transition definition table 211, respectively, the procedure 1300 makes a search (1903). The flow proceeds to 1905 if any record was hit in the search at step 1903, and proceeds to 1908 if no record was hit (1904). At 1905, the procedure 1300 determines the field value of the synchronous information 504 of the record hit in the search made at 1903. If the field value indicates “synchronous,” the flow proceeds to 1906. If the field value indicates “asynchronous,” the flow proceeds to 1907. At 1906, the procedure 1300 calls the state transition request synchronous process procedure 1400 with the value of the process instance ID, one of the arguments, the field value of the process definition name 500 and the field value of the transition ID 501 in the record hit in the search made at 1904 used as arguments. At 1907, the procedure 1300 calls the state transition request asynchronous process procedure 1500 with the value of the process instance ID, one of the arguments, and the field value of the process definition name 500 and the field value of the transition ID 501 in the record hit in the search made at 1904 used as arguments, followed by termination of the flow.

Next, the operation of the state transition request synchronous process procedure 1400 will be described.

The state transition request synchronous process procedure 1400 takes a process instance ID, a process definition name and a transition ID as input arguments. Actually, the procedure 1400 merely passes the values of the arguments to the state transition process procedure 1600 as they are.

Next, the operation of the state transition request asynchronous process procedure 1500 will be described.

The state transition request asynchronous process procedure 1500 takes a process instance ID, a process definition name and a transition ID as input arguments. Actually, the procedure 1500 merely passes the values of the arguments to the state transition request store procedure 1501 as they are.

Next, the operation of the state transition request store procedure 1501 will be described.

The state transition request store procedure 1501 takes a process instance ID, a process definition name and a transition ID as input arguments, inserts records which have the values of the respective arguments as field values of the process instance ID 900, process definition name 901 and transition ID 902 into the state transition request table 215, and terminates.

Next, the operation of the state transition request fetch procedure 1502 will be described.

The state transition request fetch procedure 1502 takes a process instance ID, a process definition name and a transition ID as output arguments, and returns a TRUE/FALSE value.

First, the procedure 1502 selects an arbitrary record from the state transition request table 215. If the procedure 1502 fails to select any record, the procedure 1502 returns FALSE to a caller, and terminates. If the procedure 1502 selects a record, the procedure 1502 sets a field value of the process instance ID 900, a field value of the process definition name 901, and a field value of the transition ID 902 of the selected record to the output arguments, and deletes the selected record from the state transition request table 215. Next, the procedure 1502 returns TRUE to the caller, and terminates.

Next, the operation of the state transition process start procedure 1503 will be described.

First, the procedure 1503 calls the state transition request fetch procedure 1502. If a response is FALSE, the procedure 1503 terminates. If TRUE, the procedure 1503 passes the values of output arguments to the state transition process procedure 1600 as they are, calls the procedure 1600, and terminates.

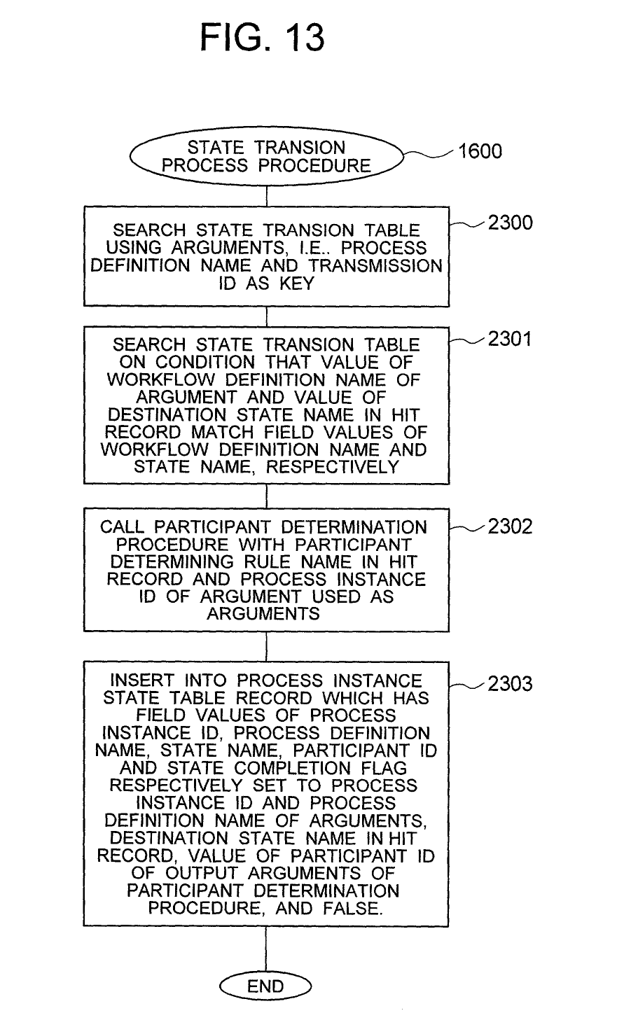

Next, the operation of the state transition process procedure 1600 will be described with reference to FIG. 13.

The state transition process procedure 1600 takes a process instance ID, a process definition name and a transition ID as input arguments.

First, on condition that the values of the process definition name and the transition ID, which are arguments, match field values of the process definition name 500 and the transition ID 501, respectively, in the transition definition table 211, the procedure 1600 searches the transition definition table 211 (2300). Then, on condition that the value of the process definition name, which is one of the arguments, and a field value of the destination state name 503 of a record hit in the search made at 2300 match a field value of the process definition name 400 and a field value of the state name 401, respectively, in the state definition table 210, the procedure 1600 searches the state definition table 210 (2301). Then, the procedure 1600 passes a field value of the participant determining rule name 402 of a record hit in the search made at 2301, and the process instance ID, which is an argument, to call the participant determination procedure 1700 (2302). The procedure 1600 sets the values of the process instance ID and the process definition name, which are arguments, a filed value of the destination state name 503 of data searched at 2300, the value of the participant ID acquired at 2302, and the “FALSE” value as field values of the process instance ID 800, process definition name 801, state name 802, participant ID 803 and state completion flag 804, respectively, and inserts the resulting record into the process instance state table 214 (2303). Then, the procedure 1600 terminates.

Next, the operation of the participant determination procedure 1700 will be described.

The participant determination procedure 1700 takes a process instance ID and a participant determining rule name as input arguments, and a participant ID as an output argument.

First, the procedure 1700 searches the participant determining rule definition table 212 using the participant determining rule name, which is an argument, as a key, buries the process instance ID, which is an argument, in a field value of the participant determining rule 601 of a hit record as required, and searches the participant definition table 213. Assuming, for example, that a buried variable is “% process instance ID %” and the value of the process instance ID, which is an argument, is “80010,” the participant determining rule on the first line in FIG. 1 is expanded as follows:

“IF window service table. process instance ID=80010.

AND window service table. trade amount>=1000000

THEN role ID=60010

ELSE role ID=60011

As the result of evaluating this rule, “role ID=60010” is obtained, and a record of the participant definition table 213 with the participant ID set to 90020 is obtained.

The procedure 1700 sets a field value of the participant ID 700 of the record in the participant ID which is the output argument, and terminates.

Next, the operation of the monitor start procedure 1800 will be described.

The monitor start procedure 1800 is called when the workflow management program 140 is started. Assume that an active flag referenced in the procedure is TRUE when the program 140 is started, and transitions to FALSE when the program 140 is terminated. First, the procedure 1800 calls the state transition process start procedure 1503. Then, the procedure 1800 waits for a fixed interval or until the active flag transitions to FALSE. The procedure 1800 determines whether or not the active flag is TRUE, and returns to the start point if YES, and terminates if NO.

In the following, the operation of the process definition tool 141 will be described in detail with reference to FIGS. 2, 14 and 15.

The process definition program 209 comprises a process definition procedure 2600 which is a main flow of the process definition; a process definition screen display procedure 2601 which displays a process definition screen, manages each object on the screen, and acquires attributes of objects for conversion into an internal data structure; and a process definition store procedure 2602 which stores the internal data structure generated by the process definition screen display procedure 2601 in the process definition data 142.

In continuation, the operation of each procedure will be described.

The operation of the process definition procedure 2600 will be described.

The procedure 2600 first calls a process definition screen display procedure 2601. Next, the procedure 2600 determines whether or not a return value from the process definition screen display procedure 2601 is TRUE. The procedure 2600 terminates if the determination result is NO, and calls a process definition store procedure 2602 if YES, followed by termination.

Next, the operation of the process definition screen display procedure 2601 will be described.

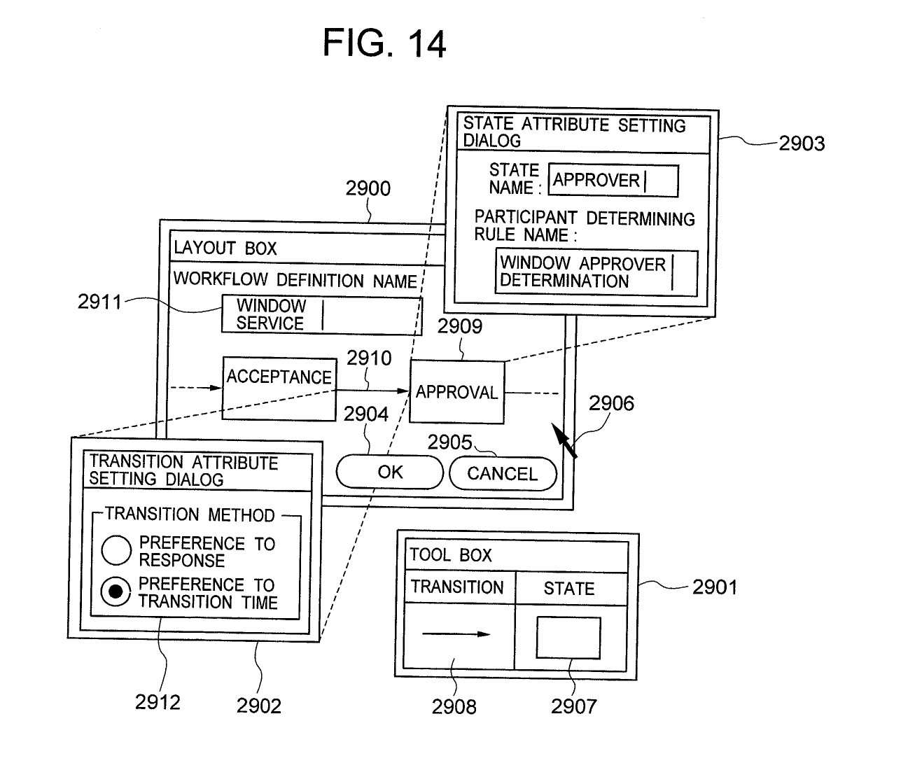

First, FIG. 14 illustrates an image on the screen of a display 123 on which the process definition screen display procedure 2601 is implemented. The process definition tool 141 can accept characters and symbols inputted through a keyboard, and manipulates a mouse pointer 2906 indicative of a point on the screen using a mouse. The user can define a workflow by dragging and dropping a state object 2907 and a transition object 2908 from a tool box 2901 to a layout box 2900. A process definition name is set in a text box 2911. As the mouse is double clicked on the state object 2909 and the transition object 2910 pasted on the layout box 2900, a state attribute setting dialog 2903 and a transition attribute setting dialog 2902 can be opened, respectively, allowing the user to set attributes. Particularly, the transition attribute setting dialog 2902 allows the user to set an attribute linked to a transition process mode using a transition method radio box 2912.

When a created process definition is stored in the process definition data 142, the mouse is clicked on an OK button 2904, while the mouse is clicked on a CANCEL button 2905 when the created process definition is canceled, followed by termination of the process definition screen display procedure 2601. Attributes to each object on the layout box 2900 can be referenced from the process definition screen display procedure 2601.

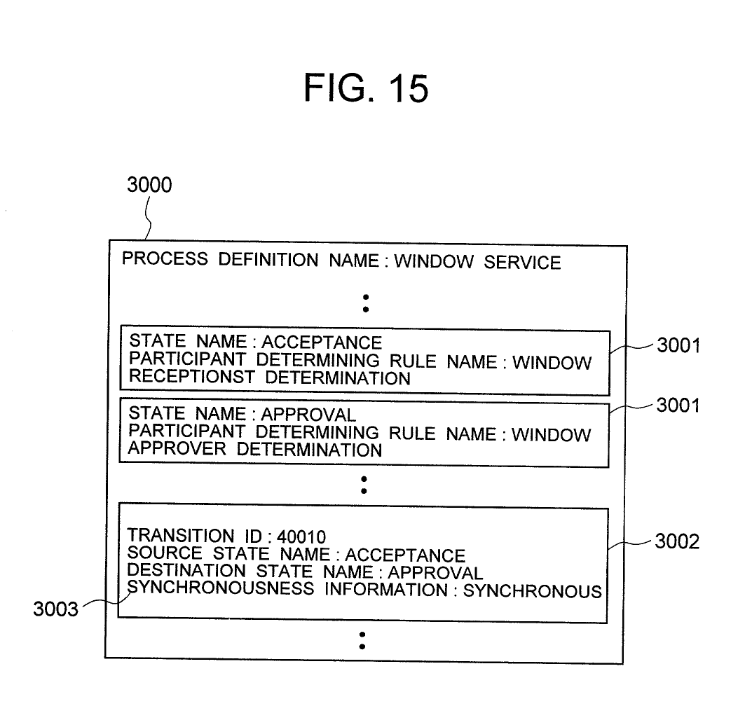

As the mouse is clicked on the OK button 2904 or the CANCEL button 2905, the control is returned to the process definition screen display procedure 2601 which determines whether the mouse is clicked on the OK button 2904. If NO, the procedure 2601 erases the layout box 2900 and the tool box 2901, returns FALSE to a caller, and terminates. If YES, the procedure 2601 stores attributes of each object other than transitions placed on the layout box 2900 in process definition structure variables which can be accessed in the process definition tool 141. The process definition structure variable has a structure as a process definition structure 3000 shown in FIG. 15. A state structure body 3001 and a transition structure body 3002 are managed in a variable length list. Next, each of transition objects 2910 placed on the layout box 2900 is assigned a unique ID in the associated process definition. Attributes of each transition object 2910 are stored in workflow structure variables. In this event, synchronousness information 3003 is set to “asynchronous” when preference to response is selected in the transition method radio box 2912, and to “synchronous” when preference to transition time is selected. Then, the procedure 2601 erases the layout box 2900 and the tool box 2901, returns TRUE to a caller, and terminates.

Next, the operation of the process definition store procedure 2602 will be described.

The process definition store procedure 2602 stores respective attributes of process definition structure variables in the state definition table 210 and the transition definition table 211, respectively, and terminates.

Next, FIG. 1 illustrates in block diagram an exemplary apparatus which implements the workflow management system to which the present invention is applied.

A server computer 100 and a plurality of client computers 101 are interconnected through a network 102.

The server computer 100 comprises a CPU 120, a keyboard 121, a mouse 122, a display 123, a communication device 124, an auxiliary storage device 125, a main storage device 126, and a bus 127. The auxiliary storage device 125 stores the process definition data 142 and the workflow data 143, while the main storage device 126 is loaded with the workflow management program 140 and the process definition tool 141 for execution. The process definition data 142 and the workflow data 143 are created when the workflow management program 140 is installed. The process definition data 142 is updated when a process definition is created using the process definition tool 141, and is referenced when the workflow management program 140 operates a process instance. The workflow data 143 is referenced and updated when a process instance is operated in the workflow management program 140.

Each of the client computers 101 in turn comprises a CPU 130, a keyboard 131, a mouse 132, a display 133, a communication device 134, an auxiliary storage device 135, a main storage device 136, and a bus 137. The auxiliary storage device 135 stores the business data 153 and the workflow application run time execution environment information 154, while the main storage device 136 is loaded with the workflow application 150, a workflow application generating tool 151, and a workflow application run time execution environment information setting tool 152 for execution. The business data 153 can be accessed through the network 102 from the server computer 100. The workflow application run time execution environment information 154 is created when the workflow application 150 is installed, and referenced during execution of the workflow application 150. The workflow application run time execution environment information 154 may be referenced and updated by the workflow application run time execution environment information setting tool 152. The business data must have been created before execution of the workflow application 150, and is referenced and updated during execution of the workflow application 150, and referenced by the workflow management program 140 as required.

A similar method to the first embodiment may be implemented when the synchronousness information is included in each state, when the synchronousness information is included in each workflow, and when the synchronousness information is included in the environment information of the workflow management program.

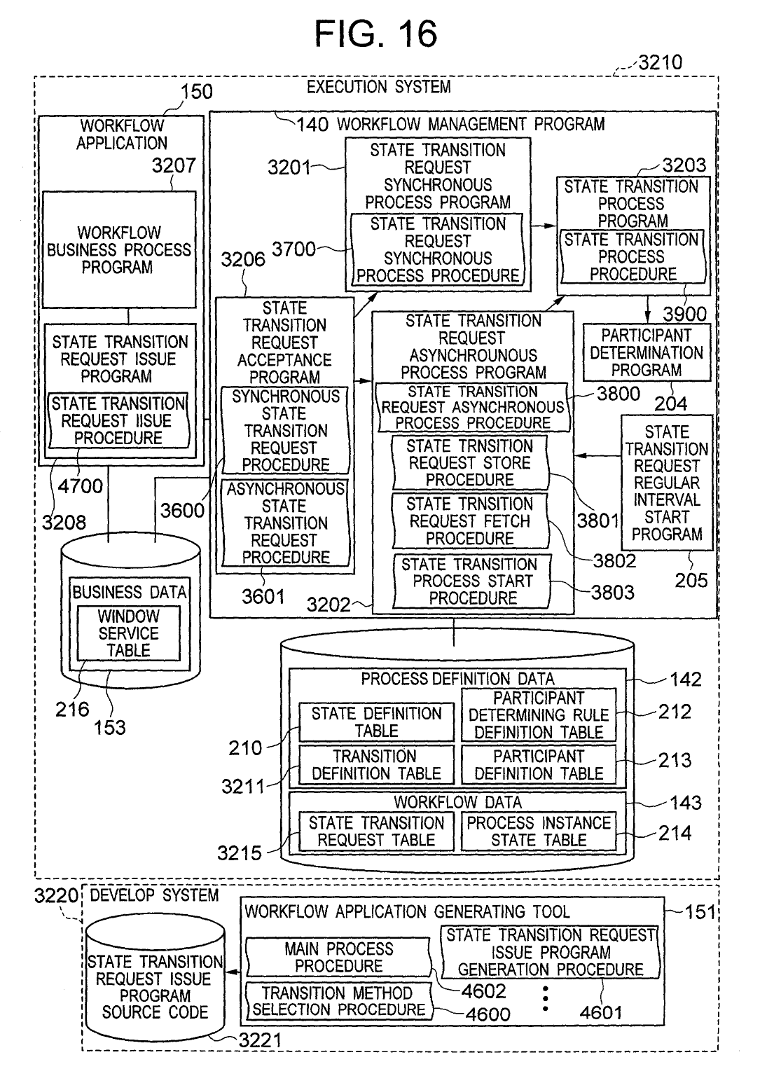

A second embodiment shows a specific example of an aspect of Solution 2 which will be described below with reference to FIGS. 16 through 23.

A workflow management system according to a second embodiment provides two types of state transition request APIs, i.e., a synchronous state transition request API and an asynchronous state transition request API, and also provides a workflow application generating tool which receives synchronousness information as an input and automatically generates a state transition request issue program source code that provides one type of state transition request interface. The workflow management system according to the second embodiment is characterized in that the workflow application generating tool determines, depending on the inputted synchronousness information, whether to generate a code for issuing the synchronous state transition request API of the workflow management program or a code for issuing the asynchronous state transition request API, such that information on state transition process methods is eliminated from user developed codes by issuing a state transition request using an interface of the state transition request issue program in a source code of a workflow business process program 3207.

The block diagram representing the workflow management system of the second embodiment is similar to that illustrated in FIG. 1.

The configuration of the workflow management system according to the second embodiment will be described with reference to FIG. 16.

The illustrated system comprises an execution system 3210 and a develop system 3220. The execution system 3210 comprises a workflow management program 140 which provides the workflow application 150 with APIs for manipulating the states of process instances, as represented by the state transition request API, and manages the states of process instances and allocation of the process instances to participants while accessing to the process definition data 142, workflow data 143 and business data 153; the process definition data 142 which stores process definitions such as possible states and transitions taken by process instances, participant determining rules, and so on; the workflow data 143 which stores the states of process instances; a workflow application 150 which accesses the business data 153 for a business which is applied with the workflow management system to call and execute APIs provided by the workflow management program 140; and the business data 153 which stores business dependent data.

The develop system 3220 comprises a workflow application generating tool 151.

The process definition data 142 comprises a state definition table 210 for storing definitions of possible states taken by process instances that depend to each process definition; a transition definition table 3211 for storing definitions of possible transitions between states taken by process instances that belong to each process definition; a participant determination rule definition table 212 for storing definitions of participant determining rules for use in determining a participant in each state; and a participant definition table 213 for storing definitions of participants.

The workflow data 143 comprises a process instance state table 214 for storing states of process instances, and a state transition request table 3215 for storing state transition requests.

The business data 153 in the second embodiment comprises and a window service table 216 for storing data depending on window services used in the second embodiment.

The workflow management program 140 comprises a state transition request synchronous process program 3201 which calls a state transition process program 3203 to implement the synchronous processing for a state transition request; a state transition request asynchronous process program 3202 which stores a state transition request in a state transition request table 3215, fetches the state transition request from the state transition request table 3215 at a timing at which it is called by a state transition request regular interval start program 205, and calls the state transition process program 3203 to implement the asynchronous processing of the state transition request; the state transition process program 3203 which references the process definition data 142, calls a participant determination program 204, and updates the process instance state table 214 to implement a state transition of a process instance; a participant determination program 204 which references the participant determining rule definition table 212 to evaluate participant determining rules, and accesses the participant definition table 213 and the window service table 216 as required to determine a participant; the state transition request regular interval start program 205 which periodically calls the state transition request asynchronous process program 3202 to give an asynchronous execution trigger for a state transition; and a state transition request acceptance program 3206 which accepts calls for the synchronous state transition request API and the asynchronous state transition request API to call the state transition request synchronous process program 3201 or the state transition request asynchronous process program 3202.

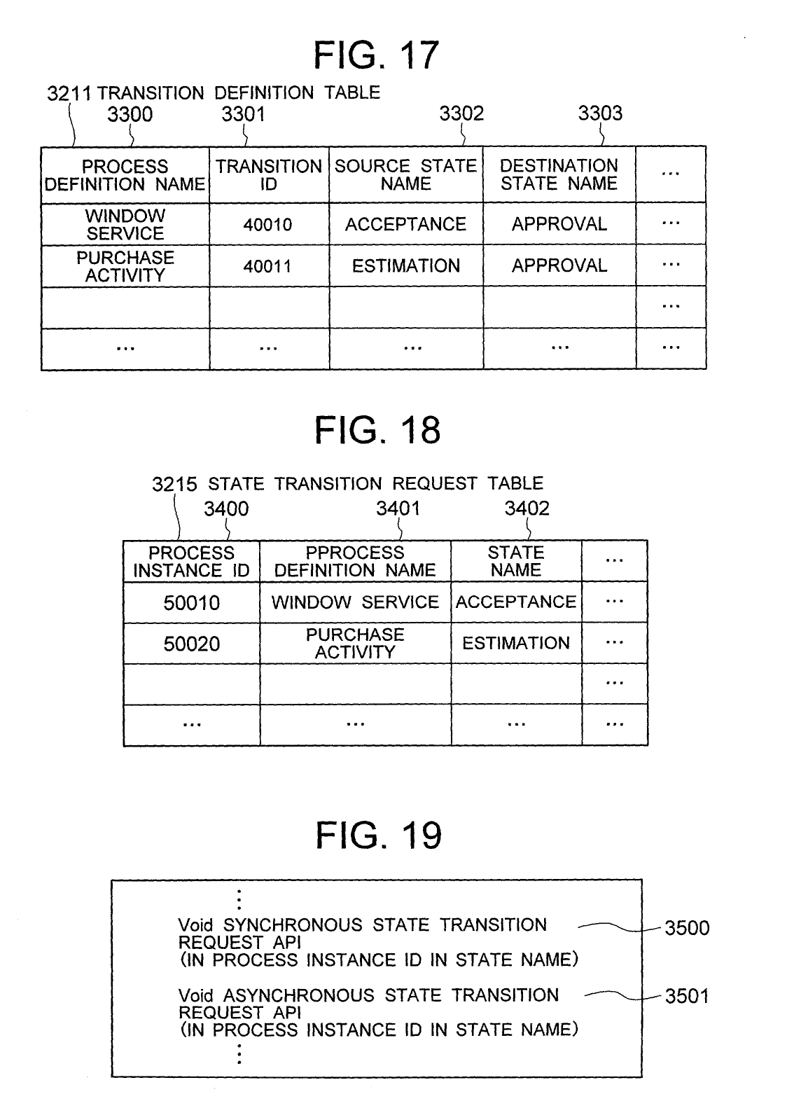

Next, tables which constitute the process definition data 142 will be described with reference to FIG. 17.

FIG. 17 shows the structure of a transition definition table 3211. The transition definition table 3211 is tabular data comprised of a process definition name 3300, a transition ID 3301, a source state name 3302, and a destination state name 3303. The process definition name 3300 indicates a process definition to which a transition belongs. The transition ID 3301 is data for uniquely identifying the transition in the same process definition. The source state name 3303 indicates the name of a state which is the source of the transition. The destination state name 3302 indicates the name of a state which is the destination of the transition.

A record in the transition definition table 3211 is stored by a process definition store procedure 2602 of the process definition program 209, and is referenced by a state transition process procedure 3900 of the state transition process program 3203.

The state definition table 210, participant determination rule definition table 212 and participant definition table 213 are similar to those of the first embodiment.

Next, a table which constitutes the workflow data 143 will be described with reference to FIG. 18. FIG. 18 shows the structure of a state transition request table 3215. The state transition request table 3215 is tabular data comprised of a process instance ID 3400, a process definition name 3401, and a state name 3402. The process instance ID 3400 is an identifier of a process instance which is associated with a state transition request. The process definition name 3401 is the name of a process definition on which a process instance, associated with a state transition request, is dependent. The state name 3402 is the name of a state specified by the state transition request API.

A record in the state transition request table 3215 is stored by a state transition request store procedure 3801 of the state transition request asynchronous process program 3202, and referenced and deleted by a state transition request fetch procedure 3802 of the state transition request asynchronous process program 3802.

The process instance state table 214 is similar to that in the first embodiment.

Also, a table which constitutes the business data 153 is similar in structure to that in the first embodiment.

In the following, the operation of the workflow management program 140 will be described in detail with reference to FIGS. 19 through 22.

FIG. 19 shows APIs provided by the workflow management program 140 which includes a synchronous state transition request API 3500 and an asynchronous state transition request API 3501. The synchronous state transition request API 3500 and the asynchronous state transition request API 3501 take a process instance ID and a state name as input arguments.

The configuration of each program will be described below.

A state transition request acceptance program 3206 comprises a synchronous state transition request procedure 3600 which implements the process of the synchronous state transition request API 3500, and an asynchronous state transition request procedure 3601 which implements the process of the asynchronous state transition request API 3501.

A state transition request synchronous process program 3201 comprises a state transition request synchronous process procedure 3700.

The state transition request asynchronous process program 3202 comprises a state transition request asynchronous process procedure 3800; a state transition request store procedure 3801 for storing a state transition request in a persistent storage; a state transition request fetch procedure 3802 for fetching a state transition request from the persistent storage; and a state transition process start procedure 3803 which is called at regular intervals to fetch a state transition request stored in the persistent storage and start the state transition process program 3203.

The state transition process program 3203 comprises a state transition process procedure 3900 which executes the actual state transition process.

The participant determination program 204 and the state transition request regular interval start program 205 are similar to those of the first embodiment.

In continuation, the operation of each procedure will be described.

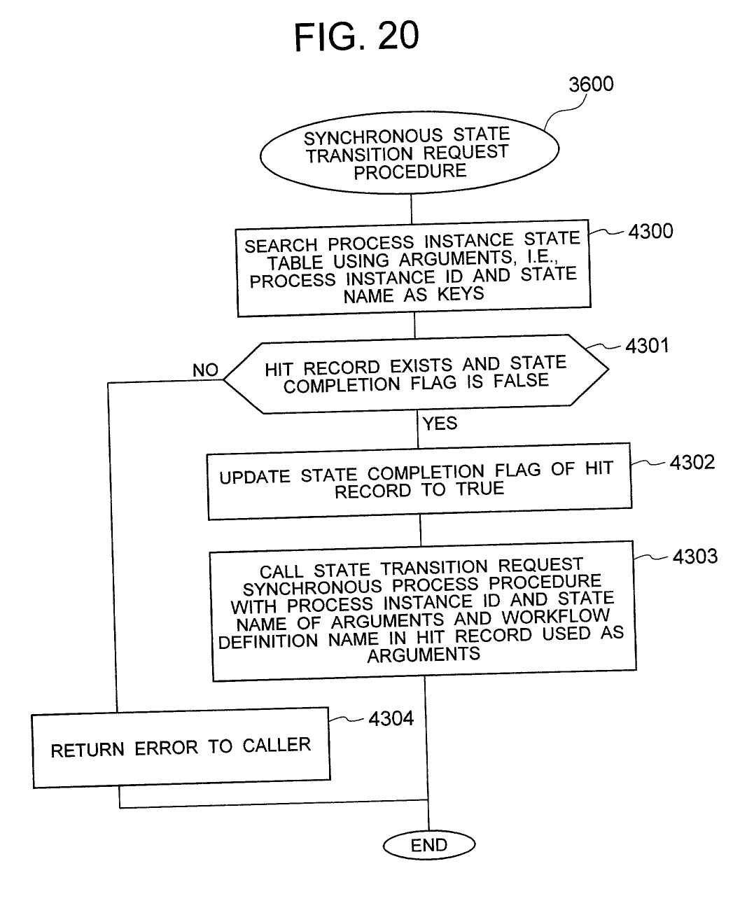

First, the operation of the synchronous state transition request procedure 3600 will be described with reference to FIG. 20.

The synchronous state transition request procedure 3600 takes a process instance ID and a state name as input arguments. First, the procedure 3600 searches the process instance state table 214 using the values of the process instance ID and the state name, which are arguments, as keys (4300). In this event, if no hit record is found in the process instance state table 214, or if the state completion flag 804 in a hit record has a field value equal to TRUE (4301), the procedure 3600 returns an error to a caller (4304), followed by termination of the flow. Otherwise, the procedure 3600 updates the field value of the state completion flag 804 in the record hit in the search made at step 4300 to TRUE (4302). Next, the procedure 3600 passes a field value of the process definition name 801 of the record hit in the search at 4300, and the values of the process instance ID and the state name, which are arguments, and calls the state transition request synchronous process procedure 3700, followed by termination of the flow.

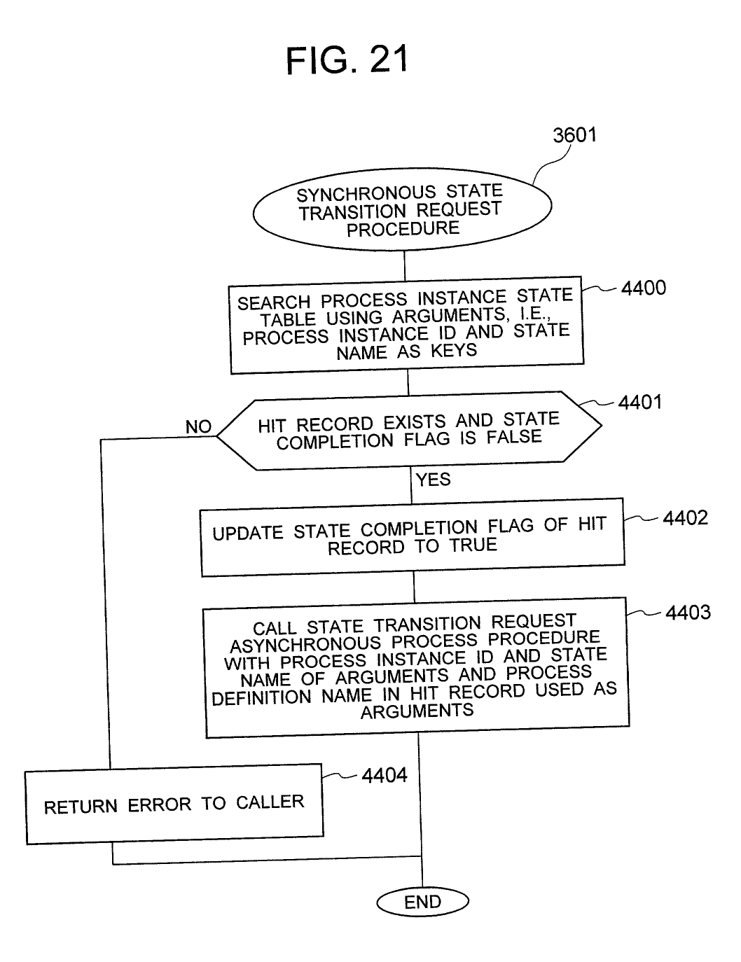

Next, the operation of the asynchronous state transition request procedure 3601 will be described with reference to FIG. 21.

The asynchronous state transition request procedure 3601 takes a process instance ID and a state name as input arguments. First, the procedure 3601 searches the process instance state table 214 using the values of the process instance ID and the state name, which are arguments, as keys (4400). In this event, if no hit record is found in the process instance state table 214, or if the state completion flag 804 in a hit record has a field value equal to TRUE (4401), the procedure 3601 returns an error to a caller (4404), followed by termination of the flow. Otherwise, the procedure 3601 updates the field value of the state completion flag 804 in the record hit in the search at step 4400 to TRUE (4402). Next, the procedure 3601 passes a field value of the process definition name 801 of the record hit in the search at 4400, and the values of the process instance ID and the state name, which are arguments, and calls the state transition request asynchronous process procedure 3800, followed by termination of the flow.

Next, the state transition request synchronous process procedure 3700 takes a process instance ID, a process definition name and a state name as input arguments. Actually, the procedure 3700 merely passes the values of the arguments to the state transition process procedure 3900 as they are.

Next, the state transition request asynchronous process procedure 3800 takes a process instance ID, a process definition name and a state name as input arguments. Actually, the procedure 3800 merely passes the values of the arguments to the state transition request store procedure 3801 as they are.

Next, the operation of the state transition request store procedure 3801 will be described.

The state transition request store procedure 3801 inserts into the state transition request table 3215 a record which has the values of the process instance ID, process definition name and state name, which are arguments, set as respective field values corresponding thereto, and terminates.

Next, the operation of the state transition request fetch procedure 3802 will be described.

The state transition request fetch procedure 3802 takes a process instance ID, a process definition name and a state name as output arguments, and returns a TRUE/FALSE value.

First, the procedure 3802 selects an arbitrary record from the state transition request table 3215. It is determined whether a record is selected. If the procedure 3802 fails to select any record, the procedure 3802 returns FALSE to a caller, and terminates. If the procedure 3802 selects a record, the procedure 3802 sets a field value of the process instance ID 3400, a field value of the process definition name 3401, and a field value of the state name 3402 of the selected record to the output arguments, and deletes the selected record from the state transition request table 3215. Next, the procedure 3802 returns TRUE to the caller, and terminates.

Next, the operation of the state transition process start procedure 3803 will be described.

The procedure 3803 first calls the state transition request fetch procedure 3802. If a response is FALSE, the procedure 3803 terminates. If TRUE, the procedure 3803 passes the values of the output arguments to the state transition process procedure 3900 as they are, calls the procedure 3900, and terminates.

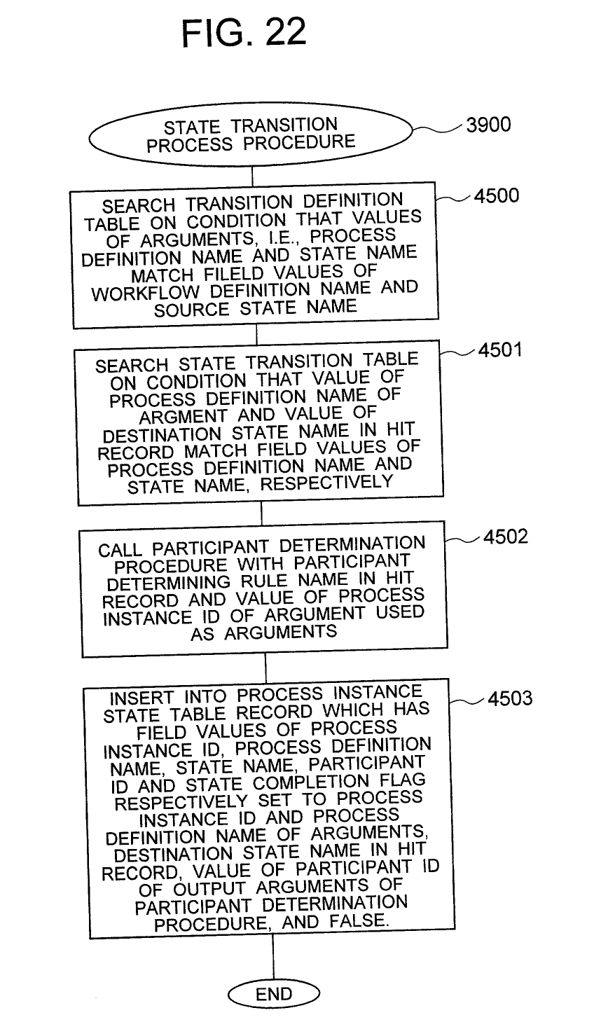

Next, the operation of the state transition process procedure 3900 will be described with reference to FIG. 22.

The state transition process procedure 3900 takes a process instance ID, a process definition name and a state name as input arguments.

First, on condition that the values of the process definition name and the state name, which are arguments, match field values of the process definition name 3300 and the source state name 3302 in the transition definition table 3211, the procedure 3900 searches the transition definition table 211 (4500). Then, on condition that the value of the process definition name, which is one of the arguments, and a field value of the destination state name 3303 of a record hit in the search made at 4500 match a field value of the process definition name 400 and a field value of the state name 401 in the state definition table 210, respectively, the procedure 3900 searches the state definition table 210 (4501). Then, the procedure 3900 passes a field value of the participant determining rule name 402 of a record hit in the search made at 4501, and the process instance ID, which is an argument, and calls the participant determination procedure 1700 (4502). The procedure 3900 sets the values of the process instance ID and the process definition name, which are arguments, a field value of the destination state name 3303 of data searched at 4500, the value of the participant ID acquired at 4502, and the “FALSE” value as field values of the process instance ID 800, process definition name 801, state name 802, participant ID 803 and state completion flag 804, respectively, of a record, and inserts the record into the process instance state table 214 (4503). Then, the procedure 3900 terminates.

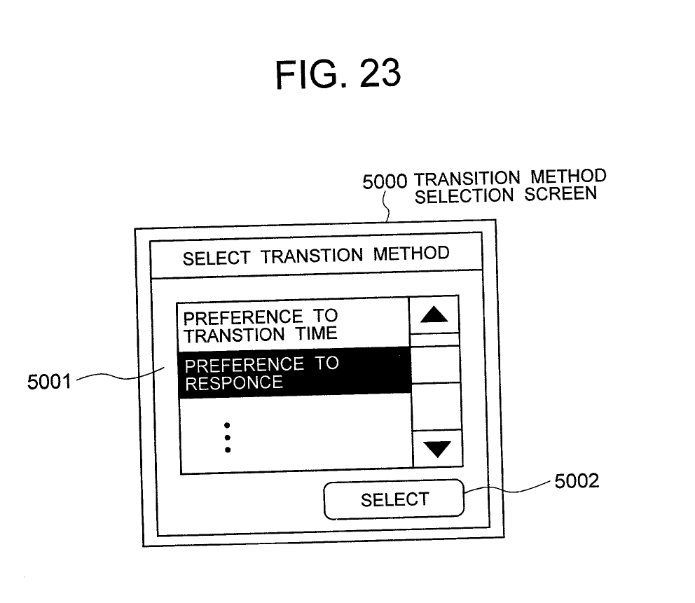

In the following, the operation of the workflow application generating tool 151 of the second embodiment, which can select a process method for a state transition request of the workflow management program 140, will be described in detail with reference to FIGS. 16 and 23.

The workflow application generating tool 151 comprises a transition method selection procedure 4600 for allowing the user to select a process method of the workflow management program 1400 for a state transition request; a state transition request issue program generation procedure 4601 for generating a state transition request issue program; and a main process procedure 4602 for controlling a main flow of the workflow application 150.

A state transition request issue program 3208 generated by the workflow application generating tool 151 has a state transition request issue procedure 4700 which can be called from the workflow business process program 3207.

The state transition request issue procedure 4700 takes a process instance ID and a state name as input arguments, passes the input arguments to the synchronous state transition request API 3500 or the asynchronous state transition request API 3501 of the workflow management program 1400, and calls one of the APIs 3500, 3501.

In the following, each of procedures included in the workflow application generating tool 151 will be described with reference to FIG. 23.

First, the operation of the main process procedure 4602 will be described.

The main process procedure 4602 calls the transition method selection procedure 4600 at some timing. Subsequently, the procedure 4602 calls the state transition request issue program generation program 4601 at some timing, and then terminates.

Next, the operation of the state transition selection procedure 4600 will be described with reference to FIG. 23.

First, the transition method selection procedure 4600 displays a transition method selection screen 5000 on the screen of the display 133 and waits for the user to select a transition method. The user can select an item in a transition method list box 5001 using a mouse 132, and click the mouse on a select button 5002 to select a transition method.

Next, the procedure 4600 stores a transition method selected on the transition method selection screen 5000 in a transition method variable which is accessible in the workflow application generating tool 151, and terminates.

Next, the operation of the state transition request issue program generation procedure 4601 will be described.

First, the procedure 4601 determines the value stored in a transition method variable which is accessible in the workflow application generating tool 151. In the second embodiment, the tool 151 generates a code for calling the synchronous state transition request API 3500 of the workflow management program 140 when the value indicates preference to transition time, and generates a code for calling the asynchronous state transition request API 3501 when the value indicates preference to response.

A state transition request issue procedure 4700, when generating the state transition request issue program 3208 for the workflow application generating tool 151 to call the synchronous state transition request API 3500, calls the synchronous state transition request API 3500 of the workflow management program 140 with the values of the process instance ID and the state name, passed through the arguments, used as arguments, returns a received response as it is, and terminates.

The state transition request issue procedure 4700, when generating the state transition request issue program 3208 for the workflow application generating tool 151 to call the asynchronous state transition request API 3501, calls the asynchronous state transition request API 3501 of the workflow management program 140 with the values of the process instance ID and the state name, passed through arguments, used as arguments, returns a received response as it is, and terminates.

The workflow business process program 3207 of the workflow application 150 performs a business process on a process instance ID subjected to the processing, and calls the state transition request issue procedure 4700 of the state transition request issue program 3208 with the process instance ID subjected to the processing and the state name used as arguments. A similar method to the second embodiment may be used when the process definition is inputted to the workflow application generating tool.

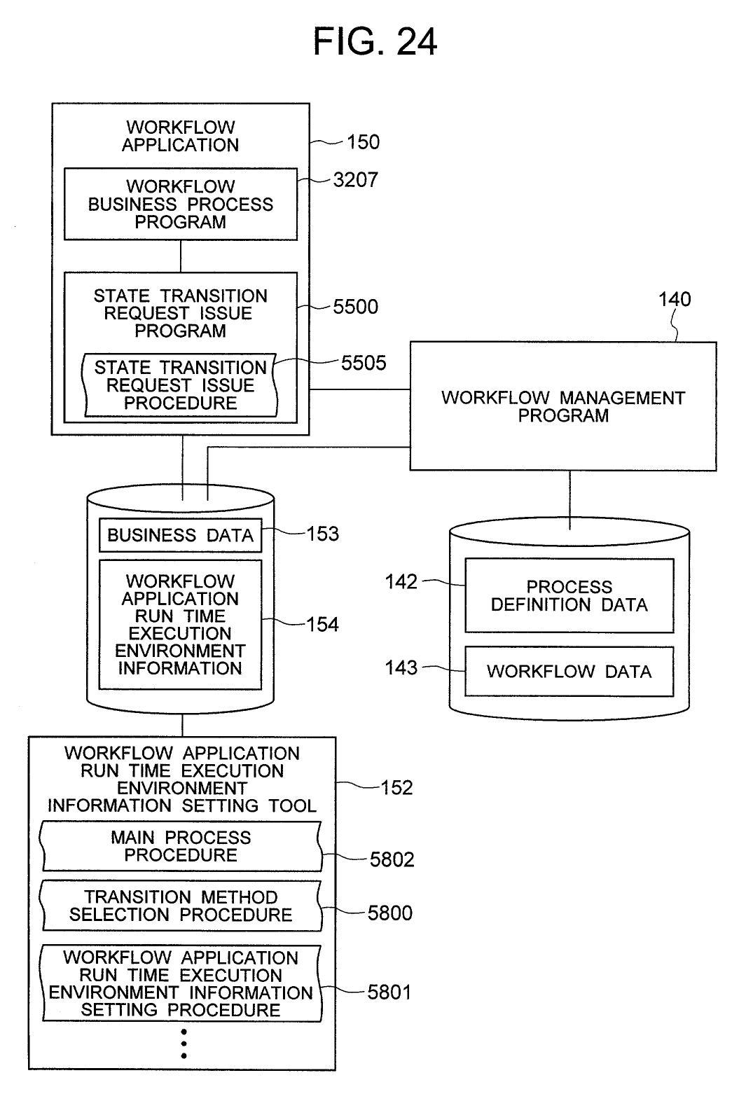

A third embodiment shows a specific example of an aspect of Solution 3 which will be described with reference to FIGS. 24 through 26.

A workflow management system according to the third embodiment provides two types of state transition request APIs, i.e., a synchronous state transition request API and an asynchronous state transition request API, and holds synchronousness information in run time execution environment information of a workflow application, so that the synchronousness information can be set using a workflow application run time execution environment information setting tool which can set the synchronousness information. A state transition request issue program references the synchronousness information to distinguish a synchronous and an asynchronous mode upon execution.

In a source code of a workflow business process program 3207, which is a user developed code, a state transition request is issued using an interface of a state transition request issue program, thereby eliminating information on state transition process methods from the user developed code.

The block diagram representing the workflow management system of the third embodiment is similar to that illustrated in FIG. 1.

The configuration of the workflow management system according to the third embodiment will be described with reference to FIG. 24.

The illustrated system comprises a workflow management program 140 which provides a workflow application 150 with APIs for manipulating the states of process instances, as represented by the state transition request API, and manages the states of process instances and allocation of the process instances to participants while accessing to process definition data 142, workflow data 143 and business data 153; the process definition data 142 which stores process definitions such as possible states and transitions taken by process instances, participant determining rules, and so on; the workflow data 143 which stores the states of process instances; a workflow application 150 which accesses the business data 153 for a business which is applied with the workflow management system 140 to call and execute APIs provided by the workflow management program 140; and the business data 153 which stores business dependent data.

The workflow management program 140, process definition data 142, workflow data 143 and business data 153 are similar to those of the second embodiment.

The third embodiment differs from the second embodiment in a state transition request issue program 5500, workflow application run time execution environment information 154, and a workflow application run time execution environment information setting tool 152. The state transition request issue program 5500 comprises a state transition request issue procedure 5505.

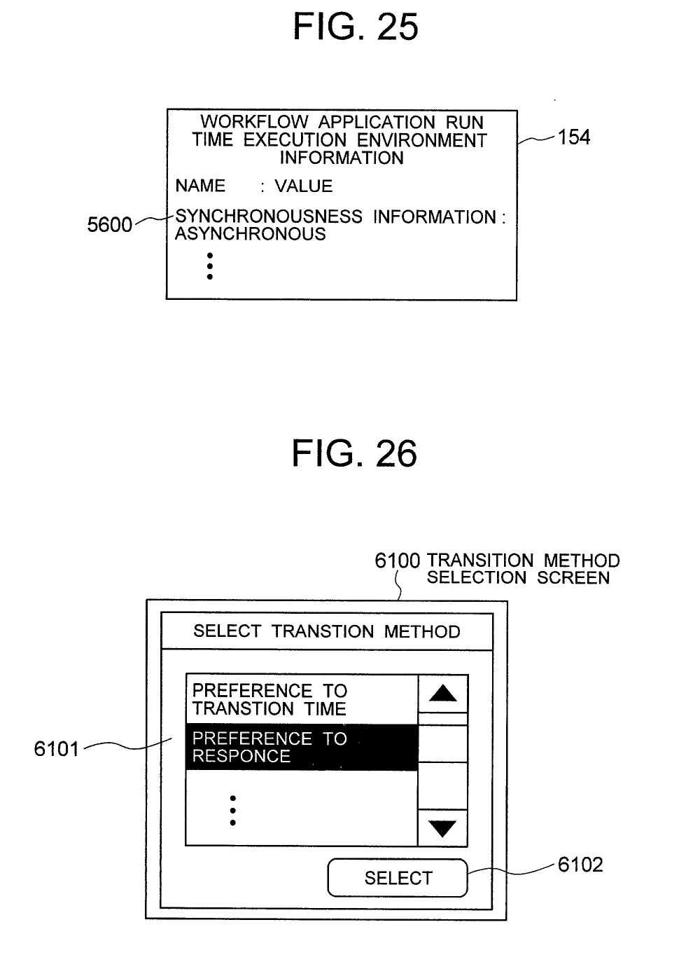

First, contents of the workflow application run time execution environment information 154 will be described with reference to FIG. 25. The workflow application run time execution environment information 154 is data which can be referenced from the workflow application 150, and also is data having names and values related thereto. For example, in FIG. 25, the workflow application run time execution environment information 154 is set “asynchronous” as synchronousness information 5600.

Next described will be contents of a process performed by the state transition request issue procedure 5505 of the state transition request issue program 5500.

The state transition request issue procedure 5505 takes a process instance ID and a state name as input arguments.

The procedure 5505 first determines whether the synchronousness information 5600 in the workflow application run time execution environment information 154 is set as synchronous or asynchronous. If data indicative of synchronous processing is set in the synchronousness information 5600, the procedure 5505 passes the process instance ID and the state name, which are arguments, and calls the synchronous state transition request API 3500. On the other hand, if data indicative of asynchronous processing is set in the synchronousness information 5600, the procedure 5505 passes the process instance ID and the state name, which are arguments, and calls the asynchronous state transition API 3501. Then, the procedure 5505 returns a response received as a result of calling the API as it is, and terminates.

In the following, the operation of the workflow application run time execution environment information setting tool 152, which can set the synchronousness information 5600 in the workflow application run time execution environment information 154, will be described in detail with reference to FIGS. 24 through 26.

The workflow application run time execution environment information setting tool 152 comprises a transition method selection procedure 5800 for allowing the user to select a process method of the workflow management program 140 for a state transition request; a workflow application run time execution environment information setting procedure 5801 for setting the workflow application run time execution environment information 1541 and a main process procedure 5802 for controlling a main flow of the workflow application run time execution environment information setting tool 152.

In the following, each of the procedures included in the workflow application run time execution environment information setting tool 152 will be described.

First, the operation of the main process procedure 5802 will be described.

The main process procedure 5802 calls the transition method selection procedure 5800 at some timing. Subsequently, the procedure 5802 calls the workflow application run time execution environment information setting procedure 5801 at some timing, and then terminates.

Next, the operation of the state transition selection procedure 5800 will be described with reference to FIG. 26.

First, the transition method selection procedure 5800 displays a transition method selection screen 6100 of FIG. 26 on the screen of the display 133, and waits for the user to select a transition method. The user can select an item in a transition method list box 6101 using a mouse 132, and click the mouse on a select button 6102 to select a transition method.

Next, the procedure 5800 stores a transition method selected on the transition method selection screen 6100 in a transition method variable which is accessible in the workflow application run time execution environment information setting tool 152, and terminates.

Next, the operation of the workflow application run time execution environment information setting procedure 5801 will be described with reference to FIG. 25.

First, the procedure 5801 determines a value stored in the state transition method variable which is accessible in the workflow application run time execution environment information setting tool 152. In the third embodiment, the tool 152 sets data for specifying the synchronous process in the synchronousness information 5600 in the workflow application run time execution environment information 154 when the value indicates preference to transition time, and sets data for specifying the asynchronous process in the synchronousness information 5600 in the workflow application run time execution environment information 154 when the value indicates preference to response.

A method similar to the third embodiment may also be implemented when a process definition is inputted to a workflow application.

The foregoing workflow management systems according to the first to third embodiments control the processing performance by switching a process method for a state transition request of a process instance between the synchronous processing mode and the asynchronous processing mode based on previously defined information.

The following embodiment will be described for a workflow management system which relatively controls the processing performance for a process associated with a state transition request of a process instance by giving the priority and limiting available computer resources based on previously defined information.

Such relative processing performance control is particularly effective in a system which is shared by a plurality of users in an environment in which computer resources are limited. For example, when services of a workflow management system are provided in the form of application hosting service such as ASP (Application Service Provider) which is drawing attention in recent years, it is necessary to appropriately manage the amount of computer resources allocated to a process for each customer or business and manage a processing schedule to provide services of quality in accordance with contents of each contract. The processing performance control method according to the present invention is also applicable to such service provision.

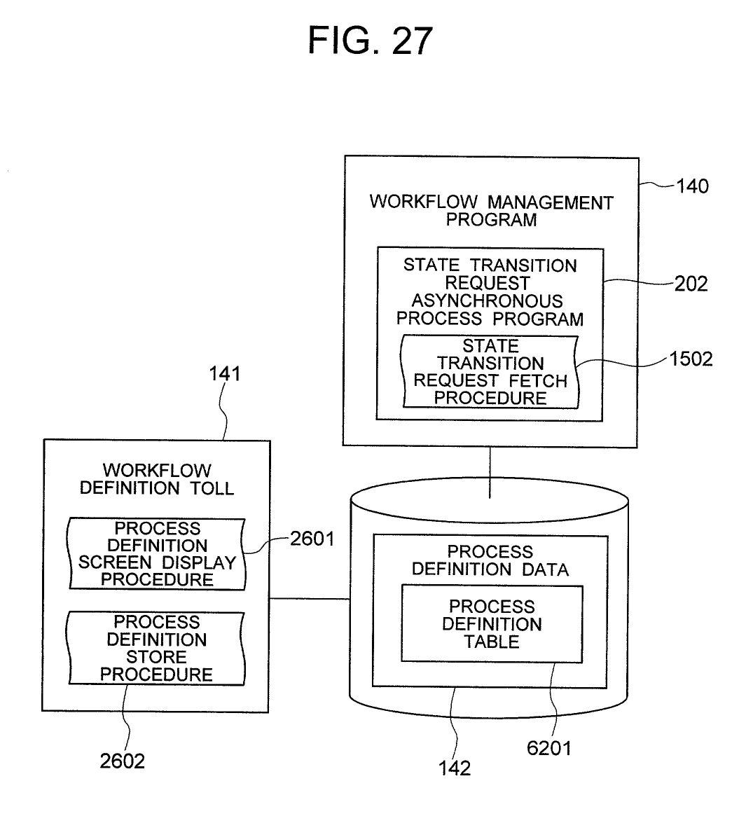

A fourth embodiment shows an example in which a workflow management system defines the priority for a process associated with a state transition request for each process definition to control the processing priority for each process definition which contains a process instance associated with the state transition request, as an embodiment of a workflow management system which controls the processing priority for state transition requests based on previously determined transition process definition information. The workflow management system according to the fourth embodiment will be described with reference to FIGS. 27 through 30.

A block diagram representing the workflow management system according to the fourth embodiment is similar to FIG. 1.

FIG. 27 illustrates the system configuration in the fourth embodiment. This system configuration additionally comprises a process definition table 6201 for storing definitions of a variety of attributes of process definitions as the process definition data 142, in the system configuration illustrated in FIG. 2. Also, the fourth embodiment modifies the processing in the state transition request fetch procedure 1502, process definition screen display procedure 2601, and process definition store procedure 2602. It should be noted that FIG. 27 only describes different components from those in the first embodiment, and does not describe details on the overall system configuration.

In the following, the fourth embodiment will be described in detail. However, to avoid redundant description, the description below will be limited only to differences with the first embodiment.

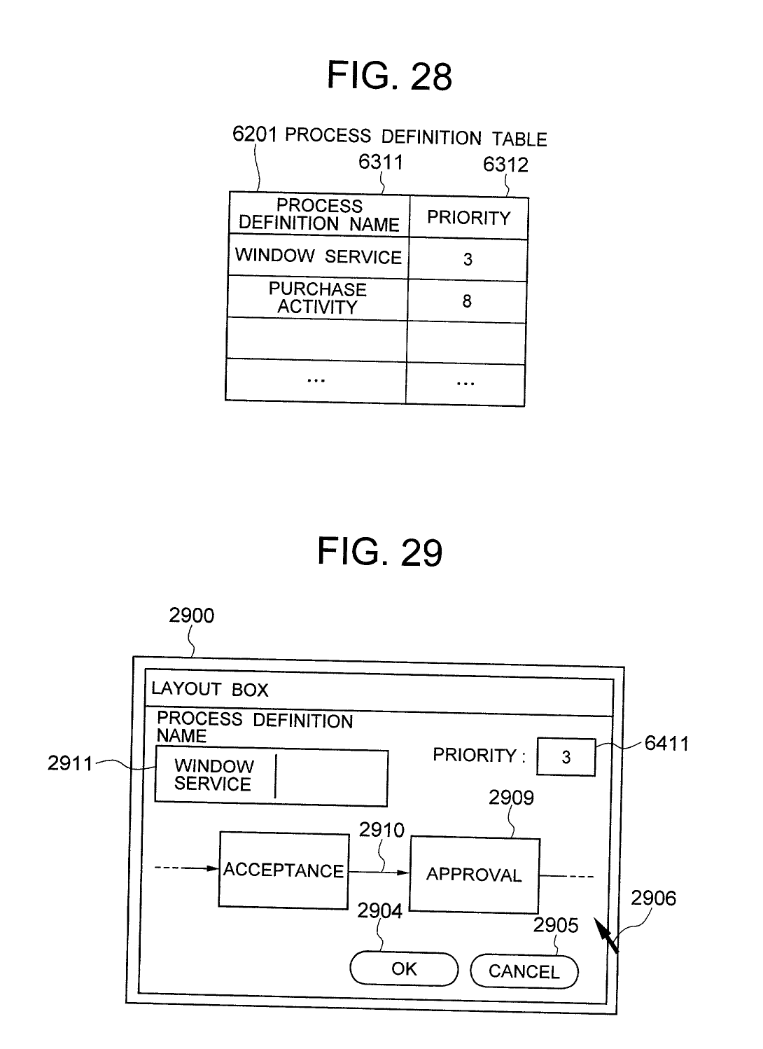

FIG. 28 shows the structure of the process definition table 6201. The process definition table 6201 is tabular data comprised of a process definition name 6311 and a priority 6312. The process definition name 6311 is data for uniquely identifying a process definition. The priority 6312 specifies the priority for processing a state transition request, and may take an arbitrary value.

A record in the process definition table 6201 is stored in the process definition store procedure 2602 of the process definition program 209, and referenced by the state transition request fetch procedure 1502 of the state transition request asynchronous process program 202.

Next, the operation of the state transition request fetch procedure 1502 will be described in the fourth embodiment.

The state transition request fetch procedure 1502 in the fourth embodiment takes a process instance ID, a process definition name and a transition ID as output arguments, and returns a TRUE/FALSE value.

First, the procedure 1502 combines the state transition request table 215 with the process definition table 6201, using the process definition name 901 in the state transition request table 215 and the process definition name 6311 in the process definition table 6201 as keys, sorts the resulting table in order from the highest priority 6312 in the process definition table 6201, and selects the first record in the sorted table. If no record is selected, the procedure 1502 returns FALSE to a caller, and terminates. If some record is selected, the procedure 1502 sets a field value of the process instance ID 900, a field value of the process definition name 901, and a field value of the transition ID 902 of the selected record in the output arguments, respectively, and deletes the selected record from the state transition request table 215. Then, the procedure 1502 returns TRUE to the caller, and terminates.

Next, the operation of the process definition screen display procedure 2601 will be described in the fourth embodiment.

First, FIG. 29 illustrates an image on the screen of a display 123 on which the process definition screen display procedure 2601 is implemented in the fourth embodiment, and differs from the first embodiment in that a text box 6411 is added for specifying the priority to state transition processing for each process definition.

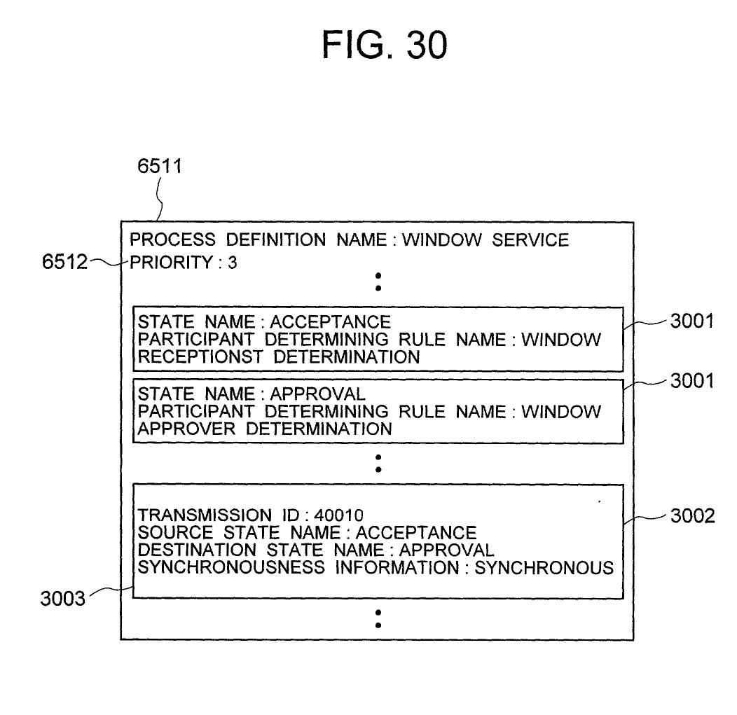

FIG. 30 shows a process definition structure 6511 for storing information related to a process definition which has been defined on the screen of FIG. 29 in the process definition screen display procedure 2601 in the fourth embodiment, and differs from the first embodiment in that a priority field 6512 is added for storing the priority entered in the text box 6411.

Next, the operation of the process definition store procedure 2602 will be described in the fourth embodiment.

The process definition store procedure 2602 in the fourth embodiment stores respective attributes of the process definition structure 6511 in the process definition table 6201, state definition table 210 and transition definition table 211, respectively, and terminates.

A similar method to the fourth embodiment may be used when the priority is set for each state, each transition, or each workflow application.

As shown above, the workflow management system according to the fourth embodiment can simply set the processing priority to a state transition request, depending on requirements of each activity, in fine granularity such as each process definition, each state, each transition, each workflow application, and so on, using an appropriate tool.

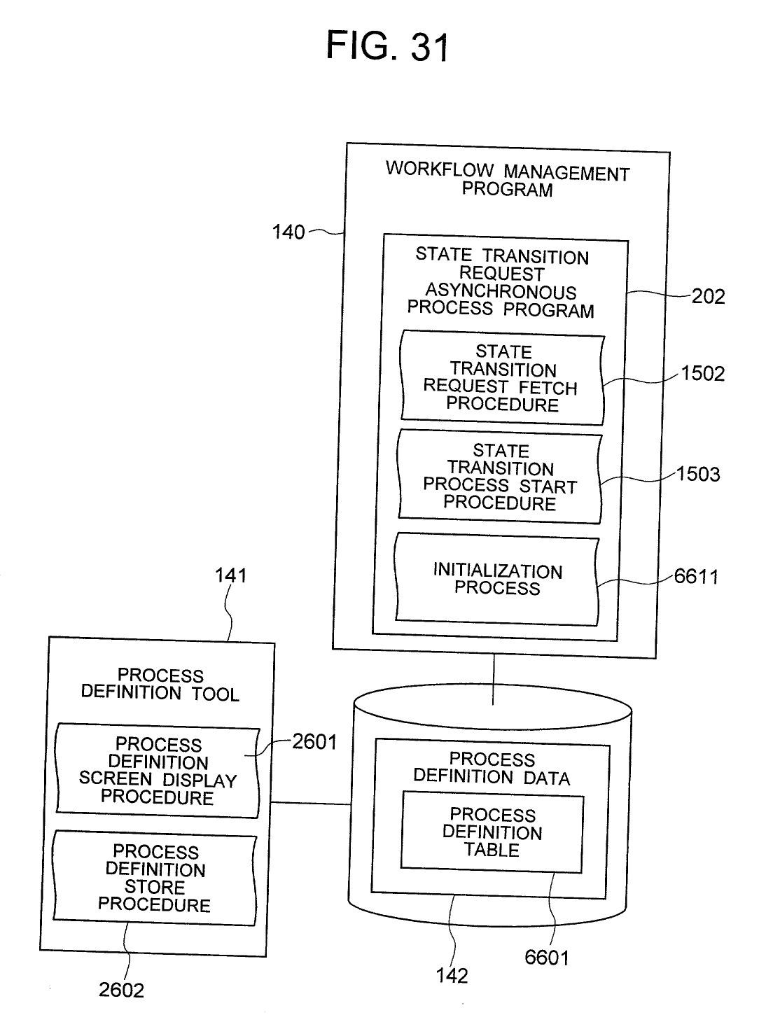

A fifth embodiment shows an example in which a workflow management system defines a maximum main storage capacity available for processing a state transition request and a main storage capacity required for processing a single state transition request for each process definition to control the main storage capacity for use in the processing for each process definition which contains a process instance associated with a state transition request, as one embodiment of a workflow management system which controls the amount of computer resources for use in processing state transition requests based on previously defined transition process definition information. The workflow management system according to the fifth embodiment will be described with reference to FIGS. 31 through 35.

A block diagram representing the workflow management system according to the fifth embodiment is similar to FIG. 1.

FIG. 31 illustrates the system configuration in the fifth embodiment. This system configuration adds a process definition table 6601 for storing a variety of attributes of process definitions, as the process definition data 142, to the system configuration illustrated in FIG. 2. The system of the fifth embodiment also comprises, in addition to the state transition request asynchronous process program 202, an initialization procedure 6611 for reserving and initializing variable regions for holding a currently used main storage capacity, a main storage capacity for use in processing a state transition, and a maximally available main storage capacity, respectively, for each process definition. Also, the system of the fifth embodiment modifies the processes of the state transition request fetch procedure 1502, state transition process start procedure 1503, process definition screen display procedure 2601 and process definition store procedure 2602. It should be noted that FIG. 31 only describes different components from those in the first embodiment, and does not describe details on the overall system configuration.

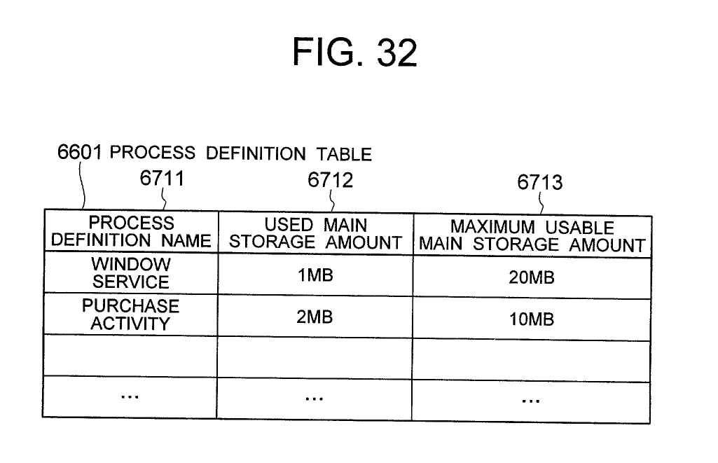

FIG. 32 shows the structure of the process definition table 6601 in the fifth embodiment. The process definition table 6601 in the fifth embodiment is tabular data comprised of a process definition name 6711, a used main storage amount 6712, and a maximum usable main storage amount 6713. The process definition name 6711 is data for uniquely identifying a process definition. The used main storage amount 6712 is data indicative of the amount of main storage required for processing a state transition request related to a process instance of the process definition. The maximum usable main storage amount 6713 is data indicative of a maximum main storage amount available for processing a state transition request related to a process instance of the process definition.

A record in the process definition table 6601 in the fifth embodiment is stored by the process definition store procedure 2602 of the process definition program 209, and referenced by an initialization procedure 6611 of the state transition request asynchronous process program 202.

Next, the operation of the initialization procedure 6611 will be described. The initialization procedure 6611 is executed only once when the workflow management program 140 is started.

First, the initialization procedure 6611 searches the process definition table 6601 for a list of process definitions. Next, the procedure 6611 reserves a variable region for holding a currently used main storage capacity (“sum of currently used amounts”); a constant region for holding a main storage capacity for use in processing a state transition (“amount used for each process”); and a constant region for holding a maximum main storage capacity available for processing a state transition (“upper limit of usable amount”) for each process definition, and initializes these regions to zero, the value of the used main storage amount 6712, and the value of the maximal usable main storage amount 6713, respectively.

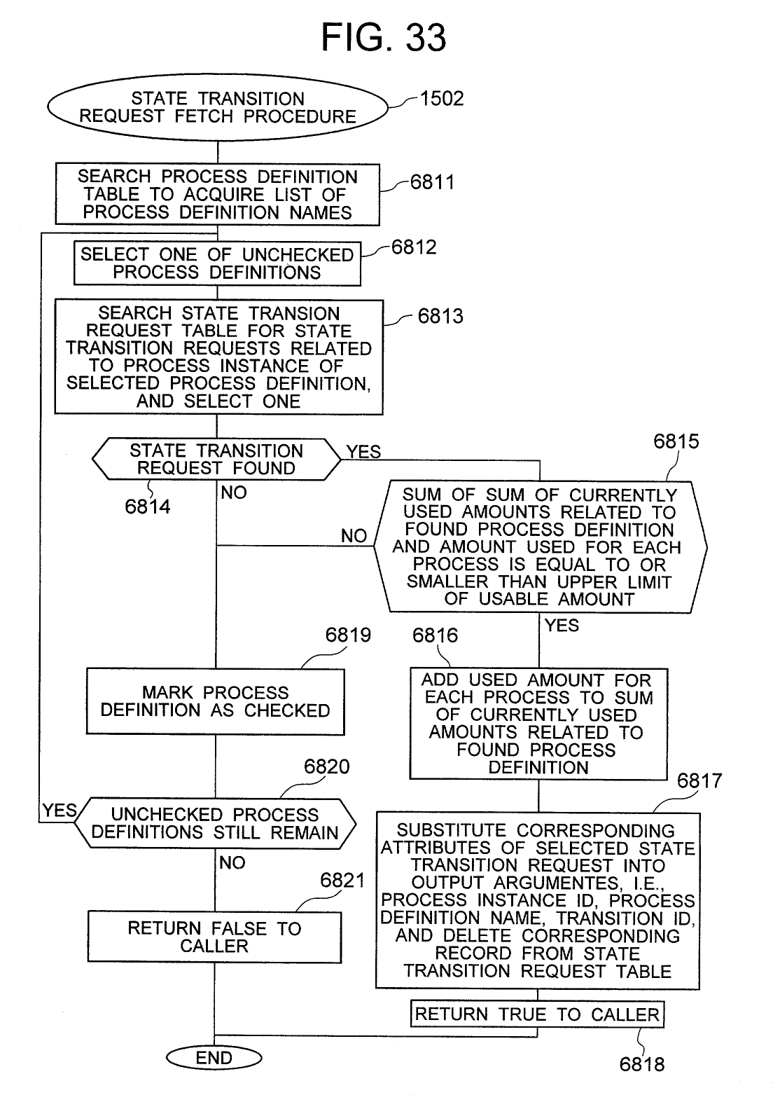

Next, the operation of the state transition request fetch procedure 1502 in the fifth embodiment will be described with reference to FIG. 33.

The state transition request fetch procedure 1502 in the fifth embodiment takes a process instance ID, a process definition name and a transition ID as output arguments, and returns a TRUE/FALSE value.

The procedure 1502 searches the process definition table 6601 to acquire a list of process definitions (step 6811). The procedure 1502 selects one of unchecked process definitions from the list of process definitions acquired at step 6811 (step 6812). The procedure 1502 searches the state transition request table 215 for state transition requests related to process instances in the process definition selected at step 6812, and selects one state transition request (step 6813). The procedure 1502 branches to step 6815 if the search at step 6813 results in any state transition request, and to step 6819 if the search results in no state transition request (step 6814). If the sum of “sum of currently used amounts” and “amount used for each process,” related to the process definitions selected at step 6812, is equal to or smaller than “upper limit of usable amount,” the procedure branches to step 6816. If the sum exceeds the “upper limit of usable amount,” the procedure branches to step 6819 (step 6815). The procedure 1502 adds “amount used for each process” to “sum of currently used amounts” related to the process definitions selected at step 6812 (step 6816). The procedure 1502 substitutes corresponding attributes of the state transition request selected at step 6813 into the output arguments, i.e., the process instance ID, process definition name, and transition ID, and deletes the corresponding record from the state transition request table 215 (step 6817). The procedure 1502 returns TRUE to a caller, and terminates (step 6818). The procedure 1502 marks the process definition selected at step 6812 as checked (step 6819). If unchecked process definitions still remain, the procedure branches to step 6812, and otherwise to step 6821 (step 6820). The procedure 1502 returns FALSE to the caller, and terminates (step 6821).

Next, the operation of the state transition process start procedure 1503 will be described in the fifth embodiment.

First, the procedure 1503 calls the state transition request fetch procedure 1502. If a response is FALSE, the procedure 1503 terminates. If the response is TRUE, the procedure 1503 passes the values of the output arguments as they are to the state transition process procedure 1600, and calls the state transition process procedure 1600. And, the procedure 1503 subtracts “amount used for each process” from “sum of currently used amounts” related to a process definition which contains a process instance associated with the state transition request, and terminates.

Next, the operation of the process definition screen display procedure 2601 will be described in the fifth embodiment.

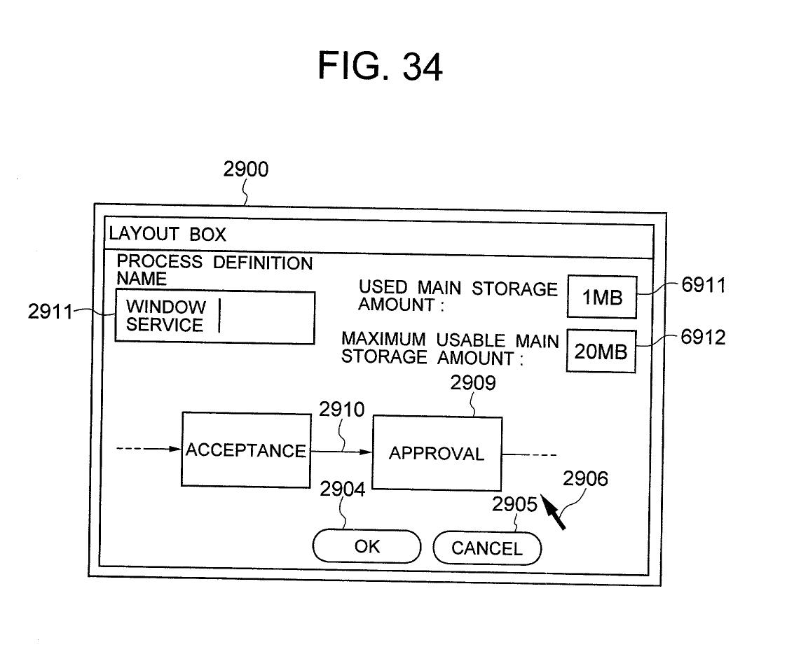

First, FIG. 34 illustrates an image on the screen of a display 123 on which the process definition screen display procedure 2601 is implemented in the fifth embodiment, and differs from the first embodiment in that a text box 6911 is added for specifying a main storage capacity required for processing a state transition, and a text box 6912 is also added for specifying an upper limit of a main storage amount available for processing a state transition, for each process definition.

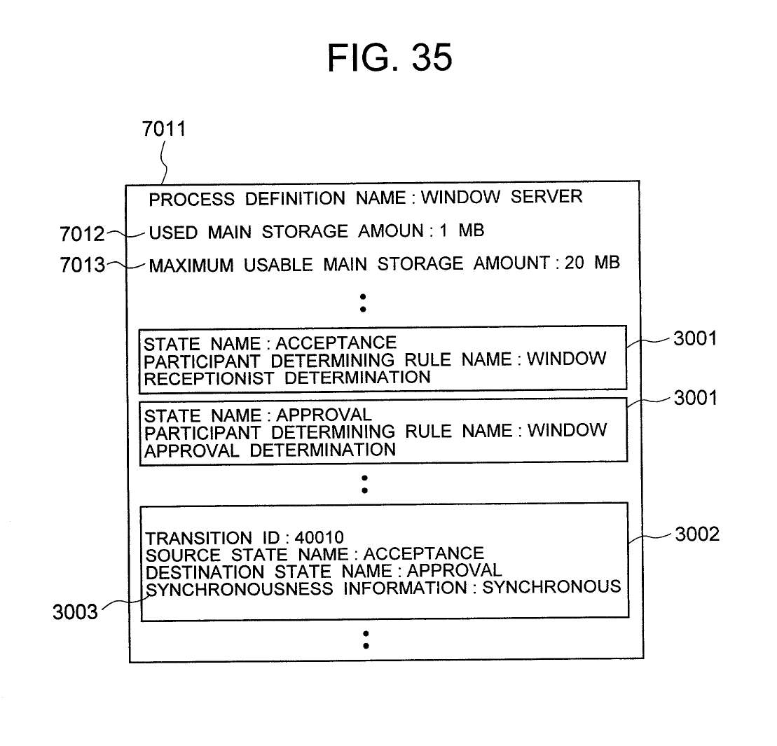

FIG. 35 shows a process definition structure 7011 for storing information related to a process definition which has been defined on the screen of FIG. 34 in the process definition screen display procedure 2601 in the fifth embodiment, and differs from the first embodiment in that the process definition structure 7011 additionally includes a used main storage amount field 7012 for storing a used main storage amount entered in the text box 6911, and a maximum usable main storage amount field 7013 for storing the amount of usable main storage entered in the text box 6912.

Next, the operation of the process definition store procedure 2602 will be described in the fifth embodiment.

The process definition store procedure 2602 in the fifth embodiment stores respective attributes of the process definition structure 7011 in the process definition table 6601, state definition table 210 and transition definition table 211, respectively, and terminates.

A method similar to the fifth embodiment may be used when a unit amount of computer resource to be controlled is set for each state, each transition, or each workflow application.

Also, a method similar to the fifth embodiment may be used when a computer resource to be controlled is the number of processing threads, an auxiliary storage capacity, and so on.

As shown above, the workflow management system according to the fifth embodiment can simply set the amount of a computer resource available for processing a state transition request, depending on requirements of each activity or service, in fine granularity such as for each process definition, each state, each transition, each workflow application, and so on using an appropriate tool.

According to the present invention, it is possible to simply set whether a state transition is processed in a synchronous mode or an asynchronous mode, depending on factors associated with the state transition performance of each business application, in fine granularity such as each process definition, each state, each transition, each workflow application, and so on, using an appropriate tool.

What is claimed is:

1. A workflow management method for previously defining a plurality of states and transitions between the states as a process definition to process a state transition for a process instance in response to an inputted state transition request, said method comprising:
a synchronous processing step for processing a state transition for a process instance during an interval of from accepting of said inputted state transition request to return of a response;
an asynchronous processing step for processing a state transition for a process instance after said inputted state transition request is accepted and a response is returned; and
a selecting step for selecting said synchronous processing step or said asynchronous processing step for execution based on inputted selection information, as a state transition process for a process instance associated for said inputted state transition request.

2. A workflow management method according to claim 1, wherein:
said selecting step includes generating a program for calling the processing step corresponding to the inputted selection information.

3. A workflow management method according to claim 1, wherein:
said selection information is previously defined synchronousness information.

4. A workflow management method according to claim 3, wherein:
said synchronousness information is included in said process definition.

5. A workflow management method according to claim 4, wherein:
said synchronousness information is included in environment information of a workflow application run time execution environment.

6. A workflow management method according to claim 3, wherein:
said synchronousness information is included in environment information of a workflow management program run time execution environment.

7. A workflow management method according to claim 4, wherein:
each transition definition between states has said synchronousness information.

8. A workflow management method according to claim 4, wherein:
each of said states has said synchronousness information.

9. A workflow management method according to claim 5, wherein:
each process definition has said synchronousness information.

10. A workflow management apparatus for previously defining a plurality of states possibly taken by a process instance, and transitions between the states as a process definition to process a state transition for the process instance in response to an inputted state transition request, said apparatus comprising:
synchronous processing means for processing a state transition for a process instance during an interval of from accepting of said inputted state transition request to return of a response;
asynchronous processing means for processing a state transition for a process instance after said inputted state transition request is accepted and a response is returned; and
selecting means for selecting said synchronous processing means or said asynchronous processing means for execution based on inputted selection information, as a state transition process for a process instance associated for said inputted state transition request.

11. A computer readable recording medium having stored thereon a workflow management program for previously defining a plurality of states possibly taken by a process instance, and transitions between the states as a process definition to process a state transition for the process instance in response to an inputted state transition request, said program comprising:
a synchronous processing step for processing a state transition for a process instance from receipt of said inputted state transition request to return of a response;
an asynchronous processing step for processing a state transition for a process instance after said inputted state transition request is accepted and a response is returned; and
an executing step for selecting said synchronous processing step or said asynchronous processing step for execution based on inputted selection information as a state transition process for a process instance associated for said inputted state transition request.

12. A workflow management method comprising the steps of:
previously defining a plurality of states possibly taken by a process instance, and transitions between the states as a process definition;
inputting a state transition request; and
controlling execution of a state transition process for a process instance associated for said inputted state transition request based on inputted transition process control information.

13. A workflow management method according to claim 12, wherein:
said state transition process control information includes priority information, said priority information being relied on when a plurality of said state transition requests should be processed, for selecting from said state transition requests a state transition request to be processed.

14. A workflow management method according to claim 12, wherein:
said state transition process control information includes available computer resource amount information, wherein said method further includes comparing the sum of a computer resource amount used for previously processed state transition requests and a computer resource amount used for said state transition request with a value defined by said available computer resource amount information to determine whether or not said state transition request is processed.

15. A workflow management method according to claim 14, wherein:
said computer resource amount is a main storage capacity used for processing said state transition request.

16. A workflow management method according to claim 14, wherein:
said computer resource amount is an auxiliary storage amount used for processing said state transition request.

17. A workflow management method according to claim 14, wherein:
said computer resource amount is the number of threads used for processing said state transition request.

18. A workflow management method according to claim 12, wherein:
said transition process control information is previously defined transition process definition information.

19. A workflow management method according to claim 18, wherein:
said transition process definition information is included in said workflow management.

20. A workflow management method according to claim 18, wherein:
said transition process definition information is included in environment information of a workflow application run time execution environment.

21. A workflow management method according to claim 18, wherein:
said transition process definition information is included in environment information of a workflow management program run time execution environment.

22. A workflow management method according to claim 19, wherein:
each transition definition between the states has said transition process definition information.

23. A workflow management method according to claim 19, wherein:
each said states has said transition process definition information.

24. A workflow management method according to claim 19, wherein:
each process definition has said transition process definition information.

25. A computer-implemented workflow management program for previously defining a plurality of states possibly taken by a process instance, and transitions between the states as a process definition to process a state transition for the process instance in response to an input state transition request, said program causing the computer to perform:
synchronously processing a state transition for a process instance from receipt of said inputted state transition request to return of a response;
causing the computer to perform asynchronously processing a state transition for a process instance after said inputted state transition request is accepted and a response is returned; and
causing the computer to perform selecting said synchronous processing or said asynchronous processing for execution based on inputted selection information as a state transition process for a process instance associated for said input state transition request.
